(19) United States
(12) Patent Application Publication
(10) Pub. No.: US 2025/0326242 A1
(43) Pub. Date: Oct. 23, 2025

(54) THERMOSENSITIVE RECORDING MEDIUM

(71) Applicant: Oji Holdings Corporation, Tokyo (JP)

(72) Inventors: Takashi TAKEMURA, Tokyo (JP); Suguru TAKANO, Tokyo (JP)

(73) Assignee: Oji Holdings Corporation, Tokyo (JP)

(21) Appl. No.: 18/855,932

(22) PCT Filed: Apr. 13, 2023
(86) PCT No.: PCT/JP2023/015013

§ 371 Date: Oct. 10, 2024

(30) Foreign Application Priority Data
Apr. 14, 2022 (JP) 2022-067191
Sep. 22, 2022 (JP) 2022-151748

(51) Int. Cl. B41M 5/42; B41M 5/46

(52) U.S. Cl. CPC B41M 5/426; B41M 5/46; B41M 2205/04

(57) ABSTRACT

A heat-sensitive recording material including at least an undercoat layer and a heat-sensitive recording layer in this order on a support, the undercoat layer containing hollow particles and a binder, the heat-sensitive recording layer containing a leuco dye and a developer, the heat-sensitive recording material containing a compound represented by the following formula (1) as a first developer of the heat-sensitive recording layer:

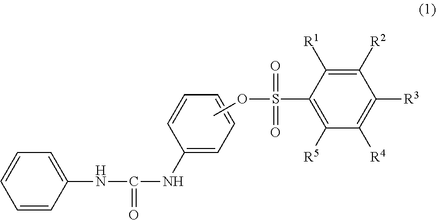

### TECHNICAL FIELD

The present invention relates to a heat-sensitive recording material.

### BACKGROUND ART

Heat-sensitive recording materials, which are in wide practical use, record color images by taking advantage of a heat-induced color development reaction between a colorless or pale-colored leuco dye and a phenol or an organic acid. Such heat-sensitive recording materials have advantages in that, for example, color images can be formed simply by the application of heat, and further, recording devices for these can be compact, can be easily maintained, and generate less noise. For this reason, heat-sensitive recording materials have been used in a broad range of technical fields as information-recording materials for printing devices such as label printers, automatic ticket vending machines, CD/ATMs, order form output devices for use in restaurants etc., data output devices in apparatuses for scientific research, etc.

In general, phenolic hydroxyl group-containing developers have drawbacks such as poor thermal response and poor water resistance of the printed portion, and phenolic compounds such as bisphenol A have an endocrine problem. Thus, there is an increasing demand, mainly in Europe, for heat-sensitive recording paper containing a non-phenolic developer, and various new non-phenolic developers have been developed.

For example, Patent Literature (PTL) 1 proposes a heat-sensitive recording material containing 3-[(phenylcarbamoyl)amino]phenyl-4-methylbenzenesulfonate, which is a non-phenolic developer, as a developer, and reports that the printed portion has excellent water resistance and that the background exhibits high stability to heat. However, although such a developer has excellent resistance to thermal background fogging at 90° C., the long-term preservation of printing is poor.

PTL 2 reports that a heat-sensitive recording material containing a combination of 3-[(phenylcarbamoyl)amino]phenyl-4-methylbenzenesulfonate and a urea urethane compound represented by the following formula (2) as developers has excellent printing runnability.

However, in PTL 1 and PTL 2, the thermal background fogging resistance is evaluated only up to 90° C. for such developers. In the market, there is a recent need for higher heat resistance, and 90° C. heat resistance is not sufficient. Thus, further improvement is required.

### CITATION LIST

### Patent Literature

PTL 1: JP6529197B
PTL 2: JP7072130B

### SUMMARY OF INVENTION

### Technical Problem

A primary object of the present invention is to provide a heat-sensitive recording material that is excellent in long-term preservation of printing.

A primary object of another embodiment of the present invention is to provide a heat-sensitive recording material that has high sensitivity and is excellent in thermal background fogging resistance and plasticizer resistance of the printed portion.

### Solution to Problem

The present inventors conducted extensive research to achieve the above objects, and found that the objects can be achieved by combining a specific developer and an inorganic pigment with an oil absorption of 130 ml/100 g or less, and by combining a compound represented by the following formula (1) and a specific developer. The present invention has been accomplished based on this finding. More specifically, the present invention provides the following heat-sensitive recording materials.

### Item 1.

A heat-sensitive recording material comprising at least an undercoat layer and a heat-sensitive recording layer in this order on a support,
the undercoat layer containing hollow particles and a binder,
the heat-sensitive recording layer containing a leuco dye and a developer,
the heat-sensitive recording material containing a compound represented by the following formula (1) as a first developer of the heat-sensitive recording layer:

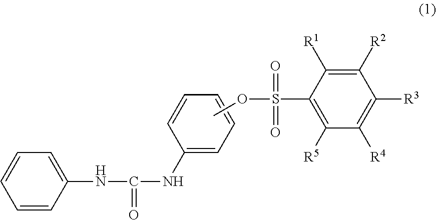

wherein R¹ to R⁵ are the same or different, and each represents a hydrogen atom, a halogen atom, a nitro group, an amino group, an alkyl group, an alkoxy group, an aryloxy group, an alkylcarbonyloxy group, an arylcarbonyloxy group, an alkylcarbonylamino group, an arylcarbonylamino group, an alkylsulfonylamino group, an arylsulfonylamino group, a monoalkylamino group, a dialkylamino group, or an arylamino group,
the heat-sensitive recording material satisfying either the following requirement (A) or (B):
(A) the undercoat layer contains an inorganic pigment I, and the heat-sensitive recording layer contains a pigment with an oil absorption of 130 ml/100 g or less as an inorganic pigment II; or
(B) the heat-sensitive recording layer contains 5-(N-3-methylphenyl-sulfonamide)-N′,N″-bis-(3-methylphenyl)-isophthalic acid diamide or N-[2-(3-phenylureido)phenyl]benzenesulfonamide as a second developer, and the second developer is contained in an amount of 0.4 to 2.5 parts by mass per part by mass of the first developer.

### Item 2.

The heat-sensitive recording material according to Item 1, wherein the compound represented by formula (1) is at least one member selected from the group consisting of 3-[(phenylcarbamoyl)amino]phenyl-4-methylbenzenesulfonate, 2-[(phenylcarbamoyl)amino]phenyl-4-methylbenzenesulfonate, and 4-[(phenylcarbamoyl)amino]phenyl-4-methylbenzenesulfonate.

### Item 3.

The heat-sensitive recording material according to Item 1, wherein the compound represented by formula (1) is 3-[(phenylcarbamoyl)amino]phenyl-4-methylbenzenesulfonate.

### Item 4.

The heat-sensitive recording material according to any one of Items 1 to 3, which satisfies requirement (A).

### Item 5.

The heat-sensitive recording material according to Item 4, wherein the content of the inorganic pigment I is 60 mass % or less, based on the total solids content of the undercoat layer.

### Item 6.

The heat-sensitive recording material according to Item 4 or 5, wherein the inorganic pigment I has an oil absorption of 130 ml/100 g or less.

### Item 7.

The heat-sensitive recording material according to any one of Items 4 to 6, wherein the inorganic pigment II has an oil absorption of 65 ml/100 g or less.

### Item 8.

The heat-sensitive recording material according to any one of Items 4 to 7, wherein the inorganic pigment II is at least one member selected from the group consisting of calcium carbonate, aluminum hydroxide, and clay.

### Item 9.

The heat-sensitive recording material according to any one of Items 1 to 3, which satisfies requirement (B).

### Item 10.

The heat-sensitive recording material according to Item 9, wherein the second developer is contained in an amount of 0.9 to 2.5 parts by mass per part by mass of the first developer.

### Item 11.

The heat-sensitive recording material according to Item 9 or 10, wherein the second developer is 5-(N-3-methylphenyl-sulfonamide)-N′,N″-bis-(3-methylphenyl)-isophthalic acid diamide.

### Item 12.

The heat-sensitive recording material according to any one of Items 9 to 11, wherein the heat-sensitive recording layer contains at least one sensitizer selected from the group consisting of dimethyl terephthalate, 1,2-di(3-methylphenoxy)ethane, stearic acid amide, and diphenyl sulfone.

### Item 13.

The heat-sensitive recording material according to any one of Items 9 to 11, wherein the heat-sensitive recording layer contains at least one sensitizer selected from the group consisting of dimethyl terephthalate and 1,2-di(3-methylphenoxy)ethane.

### Item 14.

The heat-sensitive recording material according to any one of Items 4 to 8, wherein the hollow particles have a maximum particle diameter (D100) of 10 to 30 μm and an average particle diameter (D50) of 3 to 15 μm, the ratio of the maximum particle diameter (D100) to the average particle diameter (D50), which is D100/D50, is 1.8 to 3.0, and the volume % of hollow particles with a particle diameter of 2.0 μm or less is 1% or less.

### Item 15.

The heat-sensitive recording material according to any one of Items 9 to 13, wherein the hollow particles have a maximum particle diameter (D100) of 10 to 30 μm and an average particle diameter (D50) of 4.0 to 15 μm, the ratio of the maximum particle diameter (D100) to the average particle diameter (D50), which is D100/D50, is 1.8 to 3.0, and the volume % of hollow particles with a particle diameter of 2.0 μm or less is 1% or less.

### Item 16.

The heat-sensitive recording material according to any one of Items 1 to 15, wherein the hollow particles have a hollow ratio of 80 to 98%.

### Item 17.

The heat-sensitive recording material according to any one of Items 1 to 16, wherein the content of the hollow particles is 5 to 40 mass % based on the total solids content of the undercoat layer.

### Item 18.

The heat-sensitive recording material according to any one of Items 1 to 17, wherein the binder of the undercoat layer contains a binder resin with a glass transition temperature of −10° C. or lower.

### Item 19.

The heat-sensitive recording material according to any one of Items 1 to 17, wherein the binder of the undercoat layer contains a binder resin with a glass transition temperature of −30° C. or lower.

### Item 20.

The heat-sensitive recording material according to any one of Items 1 to 19, further comprising an adhesive layer on at least one surface of the support.

### Advantageous Effects of Invention

The heat-sensitive recording material of the present invention is excellent in long-term preservation of printing.

The heat-sensitive recording material according to another embodiment of the present invention has high sensitivity and is excellent in thermal background fogging resistance and plasticizer resistance of the printed portion.

### DESCRIPTION OF EMBODIMENTS

In the present specification, the expression “comprise” or “contain” includes the concepts of “comprising,” “consisting essentially of,” and “consisting of.”

In the present specification, a numerical range indicated by “ . . . to . . . ” means a range including the numerical values given before and after “to” as the lower limit and the upper limit.

“Latex” as used herein includes one in the form of a gel or dry film formed by drying a dispersion medium.

The present invention relates to a heat-sensitive recording material comprising at least an undercoat layer and a heat-sensitive recording layer in this order on a support,
the undercoat layer containing hollow particles and a binder,
the heat-sensitive recording layer containing a leuco dye and a developer,
the heat-sensitive recording material containing a compound represented by the following formula (1) as a first developer of the heat-sensitive recording layer:

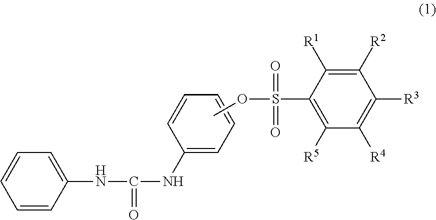

wherein R¹ to R⁵ are the same or different, and each represents a hydrogen atom, a halogen atom, a nitro group, an amino group, an alkyl group, an alkoxy group, an aryloxy group, an alkylcarbonyloxy group, an arylcarbonyloxy group, an alkylcarbonylamino group, an arylcarbonylamino group, an alkylsulfonylamino group, an arylsulfonylamino group, a monoalkylamino group, a dialkylamino group, or an arylamino group,
the heat-sensitive recording material satisfying either the following requirement (A) or (B):
(A) the undercoat layer contains an inorganic pigment I, and the heat-sensitive recording layer contains a pigment with an oil absorption of 130 ml/100 g or less as an inorganic pigment II; or
(B) the heat-sensitive recording layer contains 5-(N-3-methylphenyl-sulfonamide)-N′,N″-bis-(3-methylphenyl)-isophthalic acid diamide or N-[2-(3-phenylureido)phenyl]benzenesulfonamide as a second developer, and the second developer is contained in an amount of 0.4 to 2.5 parts by mass per part by mass of the first developer.

A heat-sensitive recording material having the feature (A) above is referred to as “heat-sensitive recording material (A),” and a heat-sensitive recording material having the feature (B) above is referred to as “heat-sensitive recording material (B).” They are described in detail below.

### A. Heat-Sensitive Recording Material (A)

In the present invention, the heat-sensitive recording material comprises at least an undercoat layer and a heat-sensitive recording layer in this order on a support,
the undercoat layer containing hollow particles, a binder, and an inorganic pigment I,
the heat-sensitive recording layer containing a leuco dye, a developer, and an inorganic pigment II,
a compound represented by formula (1) (first developer) being contained as the developer,
a pigment with an oil absorption of 130 ml/100 g or less being contained as the inorganic pigment II.

### Support

The support in the present invention is not particularly limited in type, shape, dimension, or the like. For example, high-quality paper (acid paper, neutral paper), medium-quality paper, coated paper, art paper, cast-coated paper, glassine paper, resin laminate paper, polyolefin-based synthetic paper, synthetic fiber paper, nonwoven fabrics, synthetic resin films, various transparent supports, or the like, can be appropriately selected and used. The thickness of the support is not particularly limited, and is typically about 20 to 200 μm. The density of the support is not particularly limited, and is preferably about 0.60 to 0.85 g/cm³.

### Undercoat Layer

The heat-sensitive recording material of the present invention comprises an undercoat layer between a support and a heat-sensitive recording layer, and the undercoat layer contains hollow particles, a binder, and an inorganic pigment I.

### Hollow Particles

The hollow particles are preferably formed of an organic resin from the viewpoint of enhancing cushioning properties. The undercoat layer that contains the hollow particles and thus has excellent heat-insulating properties can prevent the diffusion of heat applied to the heat-sensitive recording layer and increase the sensitivity of the heat-sensitive recording material.

Hollow particles formed of an organic resin can be divided into foamed and non-foamed types depending on the production method. Of these two types, foamed-type hollow particles typically have a larger average particle diameter and a higher hollow ratio than non-foamed-type hollow particles. Thus, foamed-type hollow particles allow for better sensitivity and image quality than non-foamed-type hollow particles.

Non-foamed-type hollow particles can be produced by polymerizing a seed in a solution, polymerizing another resin so as to cover the seed, and removing the seed inside by swelling and dissolving to form a void inside. An alkaline aqueous solution or the like is used to remove the seed inside by swelling and dissolving. Non-foamed-type hollow particles with a relatively large average particle diameter can also be produced by alkaline swelling treatment of core-shell particles in which core particles having alkaline swelling properties are coated with a shell layer that does not have alkaline swelling properties.

Foamed-type hollow particles can be produced by preparing particles in which a volatile liquid is sealed in a resin, and vaporizing and expanding the liquid in the particles while softening the resin by heating.

In the process of producing foamed-type hollow particles, the liquid in the particles is expanded by heating, thereby increasing the hollow ratio and providing excellent heat-insulating properties; thus, use of foamed-type hollow particles can enhance the sensitivity of the heat-sensitive recording material and improve the recording density. The improvement in sensitivity is particularly important in color development in a medium energy range, in which the thermal energy applied to the heat-sensitive recording layer is small. In addition, when the heat-sensitive recording layer is formed via an undercoat layer with excellent heat-insulating properties, the diffusion of heat applied to the heat-sensitive recording layer is prevented, resulting in excellent image uniformity and improved image quality. Thus, in this embodiment, it is preferable to use foamed-type hollow particles, which are excellent in improvement in the heat-insulating properties of the undercoat layer.

Examples of the resin that can be used for foamed-type hollow particles include thermoplastic resins, such as styrene-acrylic resins, polystyrene resins, acrylic resins, polyethylene resins, polypropylene resins, polyacetal resins, chlorinated polyether resins, polyvinyl chloride resins, polyvinylidene chloride resins, acrylic-based resins (e.g., an acrylic-based resin containing acrylonitrile as a component), styrene-based resins, vinylidene chloride-based resins, and copolymer resins mainly formed of polyvinylidene chloride and acrylonitrile. As gases contained in foamed-type hollow particles, propane, butane, isobutane, air, etc. can be typically used. Of the various resins, acrylonitrile resins and copolymer resins mainly formed of polyvinylidene chloride and acrylonitrile are preferred as resins that can be used for the hollow particles, from the viewpoint of the strength to maintain the shape of foamed particles.

The maximum particle diameter of the hollow particles in the present invention is preferably 10 to 30 μm, and more preferably 10 to 25 μm. The maximum particle diameter is also referred to as “D100.” When the maximum particle diameter of the hollow particles is 10 μm or more, the cushioning properties of the undercoat layer are improved; thus, the adhesion of the heat-sensitive recording material to a thermal head during printing is improved, and a heat-sensitive recording material with high image quality is obtained. This high image quality can result in improved recording density in a medium energy range, in which color is developed with energy lower than that for providing the maximum recording density (Dmax). When the maximum particle diameter of the hollow particles is 30 μm or less, the smoothness of the undercoat layer is improved; thus, the heat-sensitive recording layer provided via the undercoat layer can be made uniform, and a heat-sensitive recording material in which the formation of white spots in an image is less likely to occur can be obtained.

The average particle diameter of the hollow particles in the present invention is preferably 3 to 15 μm, and more preferably 5 to 15 μm, or preferably 4.0 to 15 μm, and more preferably 4.5 to 15 μm. The average particle diameter as used herein is the diameter at which the volume of larger particles is equal to the volume of smaller particles when particles are divided into two kinds based on the particle diameter, i.e., the median diameter, which is the particle diameter corresponding to 50 volume % frequency. The average particle diameter is also referred to as “D50.” When the average particle diameter of the hollow particles is 3 μm or more, the cushioning properties of the undercoat layer are improved; thus, the adhesion of the heat-sensitive recording material to a thermal head during printing is improved, and a heat-sensitive recording material with high image quality is obtained. This high image quality can result in improved recording density in a medium energy range, in which color is developed with energy lower than that for providing the maximum recording density (Dmax). When the average particle diameter of the hollow particles is 15 μm or less, the smoothness of the undercoat layer is improved; thus, the heat-sensitive recording layer provided via the undercoat layer can be made uniform, and a heat-sensitive recording material in which the formation of white spots in an image is less likely to occur can be obtained.

The maximum particle diameter (D100) and average particle diameter (D50) of the hollow particles can be measured using a laser diffraction particle diameter distribution analyzer. The average particle diameter (D50) may be shown according to the average value of particle diameters of 10 particles, the particle diameters being measured from the image of each particle with an electron microscope (SEM image).

The ratio of the maximum particle diameter (D100) of the hollow particles to the average particle diameter (D50) of the hollow particles, i.e., D100/D50, is an index showing the degree of particle diameter distribution. The D100/D50 ratio is preferably 1.8 to 3.0, and more preferably 2.0 to 2.8. When the D100/D50 ratio of the hollow particles is 1.8 or more, the hollow particles can be sufficiently foamed, the maximum particle diameter can be sufficiently large, the hollow ratio can be high, and the heat-insulating properties of the undercoat layer can be improved. When the D100/D50 ratio of the hollow particles is 3.0 or less, the sizes of the hollow particles are uniform, which improves the smoothness of the undercoat layer and suppresses white spots in an image.

In a particle diameter distribution determined with a laser diffraction particle diameter distribution analyzer, the volume % of hollow particles having a particle diameter of 2.0 μm or less is preferably 1% or less. It is also preferred that the volume % of hollow particles having a particle diameter of 2.0 μm or less is 0.5%, and it is more preferred that hollow particles having a particle diameter of 2.0 μm or less are not contained. Hollow particles having a particle diameter of 2 μm or less are considered to make a very small contribution to heat-insulating properties because they are too small to have a sufficient hollow area. When the volume % of hollow particles having a particle diameter of 2 μm or less in the undercoat layer is 18 or less, the recording density, image quality, etc. can be improved.

The hollow ratio of the hollow particles is preferably 80 to 98%, and more preferably 90 to 98%. When the hollow ratio of the hollow particles is 80% or more, excellent heat-insulating properties can be imparted to the undercoat layer containing the hollow particles. When the hollow ratio of the hollow particles is 98% or less, the strength of the film surrounding the hollow portion is improved, and thus hollow particles that do not collapse even when the undercoat layer is formed can be obtained.

The hollow ratio of the hollow particles is determined by measuring the true specific gravity according to the IPA method, and using the true specific gravity value as follows.

### (1) Sample Pretreatment

A sample is dried at 60° C. around the clock.

### (2) Reagent

Isopropyl alcohol (IPA: extra-pure reagent)

### (3) Measurement Method

A volumetric flask is weighed (W1).
About 0.5 g of the dried sample is weighed in the volumetric flask (W2).
About 50 mg of IPA is added thereto, and the volumetric flask is fully shaken to completely remove air outside the capsule.
IPA is added to the marked line, and the volumetric flask is weighed (W3).
As a blank, IPA alone is added to the marked line of a volumetric flask, and the volumetric flask is weighed (W4).

### (4) Calculation of True Specific Gravity

True specific gravity={(W2−W1)×((W4−W1)/100)}/{(W4−W1)−(W3−W2)}

### (5) Calculation of Hollow Ratio

Hollow ratio (%)={1−1/(1.1/true specific gravity)}×100

The hollow ratio is a value that can also be determined according to the following formula: (d³/D³)×100. In the formula, d represents the inner diameter of the hollow particles, and D represents the outer diameter of the hollow particles.

Since the hollow particles in the present invention have a relatively large particle diameter, the content of the hollow particles in the undercoat layer can be reduced. The content of the hollow particles is preferably 5 to 40 mass %, and more preferably 5 to 35 mass %, based on the total solids content of the undercoat layer. A hollow particle content of 5 masse or more can improve the heat-insulating properties of the undercoat layer, whereas a hollow particle content of 40 mass % or less makes it less likely to cause problems in terms of coating properties and the like, and makes it possible to easily form a uniform undercoat layer and improve the recording density. Further, the coating film strength of the undercoat layer can be increased.

### Binder

Examples of binders include water-soluble polymeric materials, such as polyvinyl alcohol and derivatives thereof, starch and derivatives thereof, cellulose derivatives, such as hydroxymethylcellulose, hydroxyethylcellulose, hydroxypropylcellulose, methylcellulose, and ethylcellulose, sodium polyacrylate, polyvinylpyrrolidone, acrylamide-acrylic acid ester copolymers, acrylamide-acrylic acid ester-methacrylic acid ester copolymers, styrene-maleic anhydride copolymers, isobutylene-maleic anhydride copolymers, casein, gelatin, and derivatives thereof; emulsions, such as polyvinyl acetate, polyurethane, polyacrylic acid, polyacrylic acid ester, vinyl chloride-vinyl acetate copolymers, polybutyl methacrylate, and ethylene-vinyl acetate copolymers; latexes of water-insoluble polymers, such as styrene-butadiene copolymers and styrene-butadiene-acrylic copolymers; and the like. Of these, it is preferable to use a binder containing a latex. The content of the binder can be selected from a wide range, and is typically preferably about 20 to 70 mass %, and more preferably about 25 to 60 mass, based on the total solids content of the undercoat layer.

The binder preferably contains a binder resin with a glass transition temperature (Tg) of −10° C. or lower. When the glass transition temperature is −10° C. or lower, image quality can be improved even in a low energy range. The glass transition temperature is more preferably −30° C. or lower because image quality can be further improved in a low energy range. A glass transition temperature of −50° C. or lower is not preferable because stickiness occurs. Thus, the glass transition temperature is preferably −40° C. or higher.

### Inorganic Pigment I

The undercoat layer of the present invention contains an inorganic pigment I. The oil absorption of the inorganic pigment I is preferably 130 ml/100 g or less, more preferably 125 ml/100 g or less, and even more preferably 110 ml/100 g or less, from the viewpoint of increasing recording density and improving long-term preservation. The oil absorption of the inorganic pigment I is also preferably 40 ml/100 g or more, and more preferably 80 ml/100 g or more, from the viewpoint of effectively reducing printing problems such as head residue and sticking. The oil absorption is a value determined according to the method of JIS K 5101.

Various inorganic pigments can be used as the inorganic pigment I, and preferred examples include calcined kaolin, clay, and the like. The content of the inorganic pigment I is preferably 60 mass % or less, and more preferably 50 mass % or less, based on the total solids content of the undercoat layer, from the viewpoint of improving long-term preservation. The content of the inorganic pigment I is also preferably 20 mass % or more, and more preferably 25 mass % or more, based on the total solids content of the undercoat layer, from the viewpoint of effectively reducing printing problems such as head residue and sticking.

The undercoat layer is formed on a support, for example, by mixing hollow particles, a binder, and an inorganic pigment I, and if necessary, an auxiliary agent and the like using water as a medium to prepare a coating liquid for an undercoat layer, applying the coating liquid to the support, and then drying. The coated amount of the coating liquid for an undercoat layer is not particularly limited, and is preferably about 2 to 20 g/m², and more preferably about 2 to 12 g/m² in terms of dry mass.

### Heat-Sensitive Recording Layer

### Leuco Dye

The heat-sensitive recording layer of the heat-sensitive recording material of the present invention may contain any of various known colorless or pale-colored leuco dyes. Specific examples of such leuco dyes are described below.

Specific examples of leuco dyes include dyes capable of developing blue color, such as 3,3-bis(p-dimethylaminophenyl)-6-dimethylaminophthalide, 3-(4-diethylamino-2-methylphenyl)-3-(4-dimethylaminophenyl)-6-dimethylaminophthalide, and fluoran; dyes capable of developing green color, such as 3-(N-ethyl-N-p-tolyl)amino-7-N-methylanilinofluoran, 3-diethylamino-7-anilinofluoran, 3-diethylamino-7-dibenzylaminofluoran, and rhodamine B-anilinolactam; dyes capable of developing red color, such as 3,6-bis(diethylamino)fluoran-γ-anilinolactam, 3-cyclohexylamino-6-chlorofluoran, 3-diethylamino-6-methyl-7-chlorofluoran, and 3-diethylamino-7-chlorofluoran; dyes capable of developing black color, such as 3-(N-ethyl-N-isoamyl)amino-6-methyl-7-anilinofluoran, 3-(N-methyl-N-cyclohexyl)amino-6-methyl-7-anilinofluoran, 3-diethylamino-6-methyl-7-anilinofluoran, 3-di(n-butyl)amino-6-methyl-7-anilinofluoran, 3-di(n-pentyl)amino-6-methyl-7-anilinofluoran, 3-(N-ethyl-N-isoamylamino)-6-methyl-7-alininofluoran, 3-diethylamino-7-(m-trifluoromethylanilino) fluoran, 3-(N-isoamyl-N-ethylamino)-7-(o-chloroanilino) fluoran, 3-(N-ethyl-N-2-tetrahydrofurfurylamino)-6-methyl-7-anilinofluoran, 3-(N-n-hexyl-N-ethylamino)-6-methyl-7-anilinofluoran, 3-[N-(3-ethoxypropyl)-N-ethylamino]-6-methyl-7-anilinofluoran, 3-[N-(3-ethoxypropyl)-N-methylamino]-6-methyl-7-anilinofluoran, 3-diethylamino-7-(2-chloroanilino) fluoran, 3-di(n-butylamino)-7-(2-chloroanilino) fluoran, 4,4′-bis-dimethylaminobenzhydrinbenzyl ether, N-2,4,5-trichlorophenylleucoauramine, 3-diethylamino-7-butylaminofluoran, 3-ethyl-tolylamino-6-methyl-7-anilinofluoran, 3-cyclohexyl-methylamino-6-methyl-7-anilinofluoran, 3-diethylamino-6-chloro-7-(β-ethoxyethyl)aminofluoran, 3-diethylamino-6-chloro-7-(γ-chloropropyl)aminofluoran, 3-diethylamino-6-methyl-7-anilinofluoran, 3-(N-isoamyl-N-ethylamino)-6-methyl-7-anilinofluoran, 3-dibutylamino-7-chloroanilinofluoran, 3-diethylamino-7-(o-chlorophenylamino) fluoran, 3-(N-ethyl-p-toluidino)-6-methyl-7-anilinofluoran, 3-(N-ethyl-p-toluidino)-6-methyl-7-(p-toluidino) fluoran, 3-(N-ethyl-N-tetrahydrofurfurylamino)-6-methyl-7-anilinofluoran, 3-diethylamino-6-chloro-7-anilinofluoran, 3-dimethylamino-6-methyl-7-anilinofluoran, 3-pyrrolidino-6-methyl-7-anilinofluoran, 3-piperidino-6-methyl-7-anilinofluoran, 2,2-bis{4-[6′-(N-cyclohexyl-N-methylamino)-3′-methylspiro[phthalide-3,9′-xanthen-2′-ylamino]phenyl}propane, and 3-diethylamino-7-(3′-trifluoromethylphenyl)aminofluoran; dyes having absorption wavelengths in the near-infrared region, such as 3,3-bis[1-(4-methoxyphenyl)-1-(4-dimethylaminophenyl)ethylen-2-yl]-4, 5, 6, 7-tetrachlorophthalide, 3,3-bis[1-(4-methoxyphenyl)-1-(4-pyrrolidinophenyl)ethylen-2-yl]-4, 5, 6, 7-tetrachlorophthalide, 3-p-(p-dimethylaminoanilino) anilino-6-methyl-7-chlorofluoran, 3-p-(p-chloroanilino) anilino-6-methyl-7-chlorofluoran, and 3,6-bis(dimethylamino) fluorene-9-spiro-3′-(6′-dimethylamino) phthalide; and the like. Usable leuco dyes are, of course, not limited to these compounds, and two or more of such compounds can be used in combination as necessary.

The content of the leuco dye is not particularly limited, and is preferably about 3 to 30 mass %, more preferably about 5 to 25 mass %, and even more preferably about 7 to 20 mass %, based on the total solids content of the heat-sensitive recording layer. A leuco dye content of 3 mass % or more can enhance color development ability and thus improve recording density, whereas a leuco dye content of 30 mass % or less can enhance heat resistance.

### Developer

In the present invention, the compound represented by formula (1) is contained as the first developer. The combination of the compound and the inorganic pigment II can achieve excellent long-term preservation of printing and the like.

The halogen atom represented by R¹ to R⁵ may be a fluorine atom, a chlorine atom, or a bromine atom, with a fluorine atom and a chlorine atom being preferred.

The alkyl group may be linear, branched, or cyclic, and is preferably a linear or branched alkyl group, and more preferably a linear alkyl group. Typically, the alkyl group is a C₁₋₁₂ alkyl group, preferably a C₁₋₈ alkyl group, more preferably a C₁₋₆ alkyl group, and even more preferably a C₁₋₄ alkyl group.

The alkoxy group may be linear, branched, or cyclic, and is preferably a linear or branched alkoxy group, and more preferably a linear alkoxy group. Typically, the alkoxy group is a C₁₋₁₂ alkoxy group, preferably a C₂₋₈ alkoxy group, more preferably a C₂₋₆ alkoxy group, and even more preferably a C₂₋₄ alkoxy group.

The alkylcarbonyloxy group may be linear, branched, or cyclic, and is preferably a linear or branched alkylcarbonyloxy group, and more preferably a linear alkylcarbonyloxy group. The alkylcarbonyloxy group is also preferably a C₁₋₁₀ alkylcarbonyloxy group.

The alkylcarbonylamino group may be linear, branched, or cyclic, and is preferably a linear or branched alkylcarbonylamino group, and more preferably a linear alkylcarbonylamino group. The alkylcarbonylamino group is also preferably a C₁₋₁₀ alkylcarbonylamino group.

The alkylsulfonylamino group may be linear, branched, or cyclic, and is preferably a linear or branched alkylsulfonylamino group, and more preferably a linear alkylsulfonylamino group. The alkylsulfonylamino group is also preferably a C₁₋₁₀ alkylsulfonylamino group.

The aryl group means a monocyclic or polycyclic group formed of one or more 5- or 6-membered aromatic hydrocarbon rings. Examples of aryl groups include a phenyl group, a naphthyl group, and a biphenyl group.

The aryloxy group is preferably a C₆₋₁₂ aryloxy group. The arylcarbonyloxy group is preferably a C₆₋₁₂ arylcarbonyloxy group. The arylcarbonylamino group is preferably a C₆₋₁₂ arylcarbonylamino group. The arylsulfonylamino group is preferably a C₆₋₁₂ arylsulfonylamino group.

The monoalkylamino group may be linear, branched, or cyclic, and is preferably a linear or branched monoalkylamino group, and more preferably a linear monoalkylamino group. A monoalkylamino group whose alkyl group has 1 to 10 carbon atoms is also preferable.

The dialkylamino group may be linear, branched, or cyclic, and is preferably a linear or branched dialkylamino group, and more preferably a linear dialkylamino group. A dialkylamino group whose alkyl group has 1 to 10 carbon atoms is also preferable.

The arylamino group may be a monarylamino group or diarylamino group, and is preferably a C₆₋₁₂ monoarylamino group.

Specific examples of compounds represented by formula (1) include those wherein R¹ to R⁵ are each an alkyl group or a hydrogen atom, preferably R¹ to R⁵ are each a C₁₋₈ linear alkyl group or a hydrogen atom, more preferably R¹ to R⁵ are each a C₁₋₄ linear alkyl group or a hydrogen atom, and even more preferably R¹ to R⁵ are each a methyl group or a hydrogen atom.

Other specific examples of compounds represented by formula (1) include those wherein R¹, R², R⁴, and R⁵ are each a hydrogen atom and R³ is a hydrogen atom, a halogen atom, a nitro group, an amino group, an alkyl group, an alkoxy group, an aryloxy group, an alkylcarbonyloxy group, an alkylcarbonylamino group, an arylcarbonylamino group, an alkylsulfonylamino group, an arylsulfonylamino group, a monoalkylamino group, a dialkylamino group, or an arylamino group (preferably a hydrogen atom or an alkyl group, more preferably a hydrogen atom or a C₁₋₈ alkyl group, even more preferably a hydrogen atom or a C₁₋₄ alkyl group, and particularly preferably a methyl group).

The position of the substituent bound to one benzene ring in the diphenylurea structure in formula (1) may be the ortho-position, the meta-position, or the para-position, preferably the ortho-position or the meta-position, and more preferably the meta-position with respect to the aminocarbonyl group on the benzene ring.

The compound represented by formula (1) is not particularly limited, and is preferably at least one member selected from the group consisting of 3-[(phenylcarbamoyl)amino]phenyl-4-methylbenzenesulfonate, 2-[(phenylcarbamoyl)amino]phenyl-4-methylbenzenesulfonate, and 4-[(phenylcarbamoyl)amino]phenyl-4-methylbenzenesulfonate. Of these, 3-[(phenylcarbamoyl)amino]phenyl-4-methylbenzenesulfonate is preferable.

The content of the compound represented by formula (1) is not particularly limited and can be adjusted according to the leuco dye for use. Typically, the content of the compound represented by formula (1) is preferably 0.5 parts by mass or more, more preferably 0.8 parts by mass or more, even more preferably 1 part by mass or more, still even more preferably 1.2 parts by mass or more, and particularly preferably 1.5 parts by mass or more, per part by mass of the leuco dye. The content of the compound represented by formula (1) is also preferably 10 parts by mass or less, more preferably 5 parts by mass or less, even more preferably 4 parts by mass or less, and particularly preferably 3.5 parts by mass or less, per part by mass of the leuco dye. A content of the compound represented by formula (1) of 0.5 parts by mass or more can enhance recording performance. A content of the compound represented by formula (1) of 10 parts by mass or less can effectively decrease background fogging in a high-temperature environment.

The heat-sensitive recording layer may contain another developer as long as the effects of the present invention are not impaired. Specific examples of the other developer include phenolic compounds, such as 4-tert-butylphenol, 4-acetylphenol, 4-tert-octylphenol, 4,4′-sec-butylidenediphenol, 4-phenylphenol, 4,4′-dihydroxydiphenylmethane, 4,4′-isopropylidenediphenol, 4,4′-cyclohexylidenediphenyl, 4,4′-cyclohexylidenediphenol, 1,1-bis(4-hydroxyphenyl)-ethane, 1,1-bis(4-hydroxyphenyl)-1-phenylethane, 4,4′-bis(p-tolylsulfonylaminocarbonylamino)diphenylmethane, 1,1-bis(4-hydroxyphenyl)cyclohexane, 2,2′-bis[4-(4-hydroxyphenyl)phenoxy]diethyl ether, 4,4′-dihydroxydiphenylsulfide, 4,4′-thiobis(3-methyl-6-tert-butylphenol), 4,4′-dihydroxydiphenyl sulfone, 2,4′-dihydroxydiphenyl sulfone, 2,2-bis(4-hydroxyphenyl)-4-methylpentane, 2,4′-dihydroxydiphenyl sulfone, 4-hydroxy-4′-isopropoxy diphenyl sulfone, 4-hydroxy-4′-n-propoxydiphenylsulfone, 4-hydroxy-4′-allyloxydiphenylsulfone, 4-hydroxy-4′-benzyloxydiphenyl sulfone, 3,3′-diallyl-4,4′-dihydroxydiphenylsulfone, butyl bis(p-hydroxyphenyl)acetate, methyl bis(p-hydroxyphenyl)acetate, hydroquinone monobenzyl ether, bis(3-allyl-4-hydroxyphenyl) sulfone, 4-hydroxy-4′-methyldiphenylsulfone, 4-allyloxy-4′-hydroxydiphenyl sulfone, 3,4-dihydroxyphenyl-4′-methylphenylsulfone, 4-hydroxybenzophenone, dimethyl 4-hydroxyphthalate, methyl 4-hydroxybenzoate, propyl 4-hydroxybenzoate, sec-butyl 4-hydroxybenzoate, phenyl 4-hydroxybenzoate, benzyl 4-hydroxybenzoate, 4-hydroxybenzoic acid benzyl ester, tolyl 4-hydroxybenzoate, chlorophenyl 4-hydroxybenzoate, and 4,4′-dihydroxydiphenyl ether; aromatic carboxylic acids, such as benzoic acid, p-chlorobenzoic acid, p-tert-butylbenzoic acid, trichlorobenzoic acid, terephthalic acid, salicylic acid, 3-tert-butylsalicylic acid, 3-isopropylsalicylic acid, 3-benzylsalicylic acid, 3-(α-methylbenzyl) salicylic acid, 3,5-di-tert-butylsalicylic acid, 4-[2-(p-methoxyphenoxy)ethyloxy]salicylic acid, 4-[3-(p-tolylsulfonyl)propyloxy]salicylic acid, 5-[p-(2-p-methoxyphenoxyethoxy)cumyl]salicylic acid, and zinc 4-[3-(p-tolylsulfonyl)propyloxy]salicylate; salts of these phenolic compounds or aromatic carboxylic acids with, for example, polyvalent metals, such as zinc, magnesium, aluminum, calcium, titanium, manganese, tin, and nickel; antipyrine complex of zinc thiocyanate; organic acidic substances, such as composite zinc salts of terephthalic aldehyde acid and other aromatic carboxylic acids; thiourea compounds, such as N-p-toluenesulfonyl-N′-3-(p-toluenesulfonyloxy)phenylurea, N-p-toluenesulfonyl-N′-p-butoxycarbonylphenylurea, N-p-tolylsulfonyl-N′-phenylurea, and N,N′-di-m-chlorophenylthiourea; organic compounds having a —SO₂NH— bond in the molecule, such as N-(p-toluenesulfonyl) carbamic acid p-cumylphenyl ester, N-(p-toluenesulfonyl) carbamic acid p-benzyloxyphenyl ester, N-[2-(3-phenylureido)phenyl]benzenesulfonamide, and N-(o-toluoyl)-p-toluenesulfoamide; inorganic acidic substances, such as activated clay, attapulgite, colloidal silica, and aluminum silicate; and the like.

Examples of the other developer also include urea urethane compounds represented by the following formula (2), such as 4,4′-bis[(4-methyl-3-phenoxycarbonylaminophenyl)ureido]diphenylsulfone, 4,4′-bis[(2-methyl-5-phenoxycarbonylaminophenyl)ureido]diphenylsulfone, and 4-(2-methyl-3-phenoxycarbonylaminophenyl)ureido-4′-(4-methyl-5-phenoxycarbonylaminophenyl)ureido diphenylsulfone; crosslinked diphenyl sulfone compounds represented by the following formula (3); 4,4′-bis(3-tosylureido)diphenylmethane; and the like.

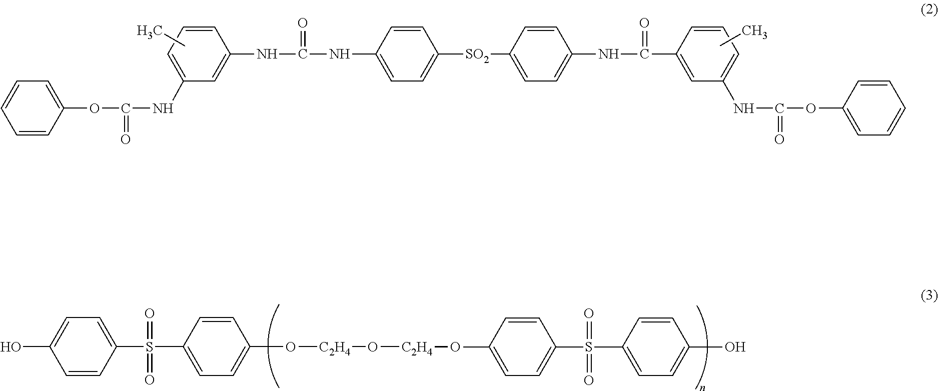

wherein n=1 to 6.

The content of the other developer is not particularly limited, and is preferably 0.5 parts by mass or less, and more preferably 0.3 parts by mass or less, per part by mass of the compound represented by formula (1).

### Inorganic Pigment II

The heat-sensitive recording layer of the present invention contains a pigment with an oil absorption of 130 ml/100 g or less as the inorganic pigment II. The oil absorption of the inorganic pigment II is preferably 125 ml/100 g or less, more preferably 100 ml/100 g or less, and most preferably 65 ml/100 g or less. This significantly improves long-term preservation. From the viewpoint of effectively reducing printing problems such as head residue and sticking, the oil absorption of the inorganic pigment II is preferably 30 ml/100 g or more. The heat-sensitive recording layer of the present invention may contain a pigment with an oil absorption of more than 130 ml/100 g as long as the effects of the present invention are not impaired. The content of the pigment with an oil absorption of more than 130 ml/100 g is preferably 0.5 parts by mass or less, more preferably 0.3 parts by mass or less, and even more preferably 0.1 parts by mass or less, per part by mass of the pigment with an oil absorption of 130 ml/100 g or less. It is particularly preferred that the heat-sensitive recording layer does not contain a pigment with an oil absorption of more than 130 ml/100 g. The oil absorption is a value determined according to the method of JIS K 5101.

Various inorganic pigments can be used as the inorganic pigment II. Specific examples include inorganic pigments, such as calcium carbonate, such as light calcium carbonate, aluminum hydroxide, clay, such as kaolin, and talc. Of these, the inorganic pigment II is preferably at least one member selected from the group consisting of calcium carbonate, aluminum hydroxide, and clay. The type of the inorganic pigment II may be different from or the same as the inorganic pigment I. The content of the inorganic pigment II can be selected from a wide range, and is preferably 10 to 50 mass %, more preferably 10 to 40 mass %, and even more preferably 15 to 35 mass, based on the total solids content of the heat-sensitive recording layer.

In the present invention, the heat-sensitive recording layer may further contain a stabilizer mainly in order to further enhance the preservation of the developed color image. As such a stabilizer, it is possible to use, for example, at least one member selected from the group consisting of phenol compounds, such as 1,1,3-tris(2-methyl-4-hydroxy-5-cyclohexylphenyl)butane, 1,1,3-tris(2-methyl-4-hydroxy-5-tert-butylphenyl)butane, 1,1-bis(2-methyl-4-hydroxy-5-tert-butylphenyl)butane, 4,4′-[1,4-phenylenebis(1-methylethylidene)]bisphenol, and 4,4′-[1,3-phenylenebis(1-methylethylidene)]bisphenol; epoxy compounds, such as 4-benzyloxyphenyl-4′-(2-methyl-2,3-epoxypropyloxy)phenylsulfone, 4-(2-methyl-1,2-epoxyethyl)diphenylsulfone, and 4-(2-ethyl-1,2-epoxyethyl)diphenylsulfone; and isocyanuric acid compounds, such as 1,3,5-tris(2,6-dimethylbenzyl-3-hydroxy-4-tert-butyl) isocyanuric acid. Usable stabilizers are, of course, not limited to these compounds, and two or more of such compounds can be used in combination as necessary.

When the stabilizer is used, its amount may be an effective amount for improving image preservation. The stabilizer is typically preferably used in an amount of about 1 to 25 mass %, and more preferably about 5 to 20 mass %, based on the total solids content of the heat-sensitive recording layer.

In the present invention, the heat-sensitive recording layer may further contain a sensitizer. Use of the sensitizer enhances the recording sensitivity. Examples of usable sensitizers include stearic acid amide, methoxycarbonyl-N-stearic acid benzamide, N-benzoyl stearic acid amide, N-eicosanoic acid amide, ethylenebisstearic acid amide, behenic acid amide, methylenebisstearic acid amide, N-methylol stearic acid amide, dibenzyl terephthalate, dimethyl terephthalate, dioctyl terephthalate, diphenylsulfone, benzyl p-benzyloxybenzoate, phenyl 1-hydroxy-2-naphthoate, 2-naphthyl benzyl ether, m-terphenyl, p-benzylbiphenyl, oxalic acid-di-p-chlorobenzyl ester, oxalic acid-di-p-methylbenzyl ester, oxalic acid-dibenzyl ester, p-tolyl biphenyl ether, di(p-methoxyphenoxyethyl)ether, 1,2-di(3-methylphenoxy)ethane, 1,2-di(4-methylphenoxy)ethane, 1,2-di(4-methoxyphenoxy)ethane, 1,2-di(4-chlorophenoxy)ethane, 1,2-diphenoxyethane, 1-(4-methoxyphenoxy)-2-(3-methylphenoxy)ethane, p-methylthiophenylbenzylether, 1,4-di(phenylthio)butane, p-acetotoluidide, p-acetophenetidide, N-acetoacetyl-p-toluidine, 1,2-diphenoxymethylbenzene, di(β-biphenylethoxy)benzene, p-di(vinyloxyethoxy)benzene, 1-isopropylphenyl-2-phenylethane, di-o-chlorobenzyl adipate, 1,2-bis(3,4-dimethylphenyl)ethane, 1,3-bis(2-naphthoxy) propane, diphenyl, benzophenone, and the like. Of these, 1,2-di(3-methylphenoxy)ethane is preferred from the viewpoint of obtaining a sensitizing effect without reducing long-term preservation. These sensitizers can be used in combination as long as the combined use does not impair the effects of the present invention. The sensitizer content may be an effective amount for sensitization, and is typically preferably 2 to 25 mass %, more preferably 5 to 20 mass %, and even more preferably 5 to 15 mass %, based on the total solids content of the heat-sensitive recording layer.

As other components that constitute the heat-sensitive recording layer, a binder can be used. Further, if necessary, auxiliary agents, such as crosslinking agents, waxes, metal soaps, water resistance improving agents, dispersants, colored dyes, and fluorescent dyes, can be used.

Examples of binders include water-soluble polymeric materials, such as polyvinyl alcohol and derivatives thereof, starch and derivatives thereof, cellulose derivatives, such as hydroxymethylcellulose, hydroxyethylcellulose, hydroxypropylcellulose, methylcellulose, and ethylcellulose, sodium polyacrylate, polyvinylpyrrolidone, acrylamide-acrylic acid ester copolymers, acrylamide-acrylic acid ester-methacrylic acid ester copolymers, styrene-maleic anhydride copolymers, isobutylene-maleic anhydride copolymers, casein, gelatin, and derivatives thereof; emulsions, such as polyvinyl acetate, polyurethane, polyacrylic acid, polyacrylic acid ester, vinyl chloride-vinyl acetate copolymers, polybutyl methacrylate, and ethylene-vinyl acetate copolymers; latexes of water-insoluble polymers, such as styrene-butadiene copolymers and styrene-butadiene-acrylic copolymers; and the like. Of these, polyvinyl alcohol, latexes, and the like are preferred. The content of the binder can be selected from a wide range, and is typically preferably about 5 to 30 mass %, and more preferably about 10 to 20 mass %, based on the total solids content of the heat-sensitive recording layer.

When the heat-sensitive recording layer contains a crosslinking agent, the water resistance of the heat-sensitive recording layer can be improved. Examples of crosslinking agents include aldehyde compounds, such as glyoxal; polyamine compounds, such as polyethyleneimine; epoxy compounds, polyamide resins, melamine resins, glyoxylic acid salts, dimethylolurea compounds, aziridine compounds, block isocyanate compounds; inorganic compounds, such as ammonium persulfate, ferric chloride, magnesium chloride, soda tetraborate, and potassium tetraborate; boric acid, boric acid triesters, boron polymers, hydrazide compounds, glyoxylic acid salts, and the like. These may be used singly, or in a combination of two or more. The amount of the crosslinking agent used is preferably about 1 to 5 mass % based on the total solids content of the heat-sensitive recording layer.

The heat-sensitive recording layer is formed on the undercoat layer, for example, by dispersing a leuco dye and a developer, and if necessary, with or separately from a sensitizer or a stabilizer, using water as a dispersion medium and using at least one of various stirrers or wet pulverizers, such as a ball mill, a co-ball mill, an attritor, or a vertical or horizontal sand mill together with a water-soluble synthetic polymer compound, such as polyacrylamide, polyvinyl pyrrolidone, polyvinyl alcohol, methylcellulose, or a styrene-maleic anhydride copolymer salt, and other additives such as a surfactant to form dispersions; then mixing the dispersions obtained by reducing the average particle diameter so that the average particle diameter is 2 μm or less with an inorganic pigment II and optionally further mixing therewith a binder, an auxiliary agent, and the like to prepare a coating liquid for a heat-sensitive recording layer; applying the coating liquid for a heat-sensitive recording layer to the undercoat layer; and then drying. The coated amount of the heat-sensitive recording layer is not particularly limited and is preferably about 1 to 12 g/m², more preferably 2 to 10 g/m², even more preferably 2.5 to 8 g/m², and particularly preferably 3 to 5.5 g/m², in terms of the coated amount after drying. Note that the heat-sensitive recording layer may be formed as two or more separate layers if necessary, and the composition and coated amount of each layer may be the same or different.

### Protective Layer

The heat-sensitive recording material can comprise a protective layer formed on the heat-sensitive recording layer as necessary. The protective layer preferably contains a pigment and a binder. The protective layer preferably further contains a lubricant, such as polyolefin wax or zinc stearate, for the purpose of preventing the layer from sticking to the thermal head. The protective layer can also contain a UV absorber. When a glossy protective layer is formed, the obtained product can have increased added value.

The pigment contained in the protective layer is not particularly limited. Examples include inorganic pigments, such as amorphous silica, kaolin, clay, light calcium carbonate, heavy calcium carbonate, calcined kaolin, titanium oxide, magnesium carbonate, aluminum hydroxide, colloidal silica, and synthetic layered mica; plastic pigments, such as urea-formalin resin fillers; and the like.

The binder contained in the protective layer is not particularly limited, and an aqueous binder selected from water-soluble binders and water-dispersible binders can be used. The binder can be appropriately selected from those that can be used for the heat-sensitive recording layer. Of these, various modified polyvinyl alcohols, such as acetoacetyl-modified polyvinyl alcohol, carboxy-modified polyvinyl alcohol, and diacetone-modified polyvinyl alcohol, can be more preferably used.

The protective layer is formed on the heat-sensitive recording layer, for example, by mixing a pigment and a binder optionally with an auxiliary agent and the like using water as a dispersion medium to prepare a coating liquid for a protective layer, applying the coating liquid to the heat-sensitive recording layer, and then drying. The coated amount of the coating liquid for a protective layer is not particularly limited and is preferably about 0.3 to 15 g/m², more preferably about 0.3 to 10 g/m², even more preferably about 0.5 to 8 g/m², particularly preferably about 1 to 8 g/m², and further particularly preferably about 1 to 5 g/m², in terms of dry mass. The protective layer may be formed as two or more separate layers if necessary, and the composition and coated amount of each layer may be the same or different.

### Other Layers

In the present invention, the heat-sensitive recording material preferably comprises an adhesive layer on at least one surface of the support. This can increase the added value of the heat-sensitive recording material. For example, adhesive paper, remoistening adhesive paper, or delayed tack paper can be formed as the adhesive layer by subjecting one surface of the support to coating with, for example, an adhesive, such as an adhesive, a remoistening adhesive, or a delayed tack adhesive. Recording paper capable of two-sided recording can also be formed by imparting to the surface of the support opposite to the heat-sensitive recording layer a function as heat transfer paper, ink jet recording paper, carbon-free paper, electrostatic recording paper, or xerography paper. Of course, the heat-sensitive recording material can be formed into a two-side heat-sensitive recording material. A back layer can also be provided to inhibit oil and plasticizer permeation from the back side of the heat-sensitive recording material, or for curl control and antistatic purposes. The heat-sensitive recording material can also be formed into linerless labels that do not require release paper by forming a silicone-containing release layer on the protective layer and applying an adhesive to the one side.

### Heat-Sensitive Recording Material

The heat-sensitive recording material can be produced by forming each layer described above on the support. Any known coating method, such as an air knife method, a blade method, a gravure method, a roll coater method, a spray method, a dip method, a bar method, a curtain method, a slot-die method, a slide die method, and an extrusion method, can be used as the method for forming each layer described above on the support. The individual coating liquids may be applied in such a manner that a first coating liquid is applied and dried and then a second coating liquid is applied and dried to form one layer after another, or the same coating liquid may be applied separately to form two or more layers. Further, simultaneous multilayer coating may also be performed, in which individual coating liquids are applied all at once to form two or more layers simultaneously. In any stage after each layer is formed or after all layers are formed, the layer may be subjected to a smoothing treatment by a known method, such as supercalendering or soft calendering.

### B. Heat-Sensitive Recording Material (B)

In the present invention, the heat-sensitive recording material comprises at least an undercoat layer and a heat-sensitive recording layer in this order on a support,
the undercoat layer containing hollow particles and a binder,
the heat-sensitive recording layer containing a leuco dye, developers, and a binder,
the heat-sensitive recording material containing a compound represented by formula (1) as a first developer of the heat-sensitive recording layer, and 5-(N-3-methylphenyl-sulfonamide)-N′,N″-bis-(3-methylphenyl)-isophthalic acid diamide or N-[2-(3-phenylureido)phenyl]benzenesulfonamide as a second developer of the heat-sensitive recording layer,
the second developer being contained in an amount of 0.4 to 2.5 parts by mass per part by mass of the first developer.

### Support

The support for use in this embodiment can be those described in the “Support” section in “A. Heat-sensitive Recording Material (A)” above.

### Undercoat Layer

The heat-sensitive recording material of the present invention comprises an undercoat layer between a support and a heat-sensitive recording layer. The undercoat layer contains hollow particles and a binder.

### Hollow Particles

The hollow particles for use can be those described in the “Undercoat Layer” section in “A. Heat-sensitive Recording Material (A)” above, and the content of the hollow particles can be set as described in the “Undercoat Layer” section in “A. Heat-sensitive Recording Material (A)” above.

### Binder

The binder for use can be those described in the “Undercoat Layer” section in “A. Heat-sensitive Recording Material (A)” above, and the content of the binder can be set as described in the “Undercoat Layer” section in “A. Heat-sensitive Recording Material (A)” above.

The undercoat layer can contain an oil-absorbing pigment with an oil absorption of 70 ml/100 g or more, and particularly about 80 to 150 ml/100 g. The oil absorption is a value determined according to the method of JIS K 5101.

The oil-absorbing pigment may be any of various types of oil-absorbing pigments. Specific examples include inorganic pigments, such as calcined kaolin, amorphous silica, light calcium carbonate, and talc. Such oil-absorbing pigments preferably have an average primary particle diameter of about 0.01 to 5 μm, and particularly about 0.02 to 3 μm. The amount of the oil-absorbing pigment used can be selected from a wide range, and is typically preferably about 20 to 60 mass %, and more preferably about 25 to 55 masse, based on the total solids content of the undercoat layer.

The undercoat layer is formed on a support, for example, by mixing hollow particles and a binder, and if necessary, an oil-absorbing pigment, an auxiliary agent, and the like using water as a medium to prepare a coating liquid for an undercoat layer, applying the coating liquid to the support, and then drying. The coated amount of the coating liquid for an undercoat layer is not particularly limited, and is preferably about 2 to 20 g/m², and more preferably about 2 to 12 g/m² in terms of dry mass.

Examples of auxiliary agents that can be contained in the coating liquid for an undercoat layer include sodium dioctyl sulfosuccinate, sodium dodecylbenzene sulfonate, sodium lauryl alcohol sulfate, metal salts of fatty acids, and like dispersants; zinc stearate, calcium stearate, polyethylene wax, carnauba wax, paraffin wax, ester wax, and like waxes; hydrazide compounds, boric acid, dialdehyde starch, glyoxylic acid salt, epoxy compounds, and like water-resistance-imparting agents; antifoaming agents; colorant dyes; fluorescent dyes; and the like.

### Heat-Sensitive Recording Layer

### Leuco Dye

The heat-sensitive recording layer of the heat-sensitive recording material of the present invention may contain any of various known colorless or pale-colored leuco dyes. The leuco dye for use can be those described in the “Heat-sensitive Recording Layer” section in “A. Heat-sensitive Recording Material (A)” above. The content of the leuco dye can be set as described in the “Heat-sensitive Recording Layer” section in “A. Heat-sensitive Recording Material (A)” above.

### Developers

In the present invention, a first developer and a second developer are contained as developers, and a compound represented by formula (1) above is contained as the first developer.

The content of the first developer is not particularly limited and can be adjusted according to the leuco dye for use. Typically, the content of the first developer is preferably 0.5 parts by mass or more, more preferably 0.8 parts by mass or more, even more preferably 1 part by mass or more, still even more preferably 1.2 parts by mass or more, and particularly preferably 1.5 parts by mass or more, per part by mass of the leuco dye. The content of the first developer is also preferably 10 parts by mass or less, more preferably 5 parts by mass or less, even more preferably 4 parts by mass or less, and particularly preferably 3.5 parts by mass or less, per part by mass of the leuco dye. A content of 0.5 parts by mass or more can enhance recording performance. A content of 10 parts by mass or less can effectively decrease background fogging in a high-temperature environment.

As the second developer, 5-(N-3-methylphenyl-sulfonamide)-N′,N″-bis-(3-methylphenyl)-isophthalic acid diamide or N-[2-(3-phenylureido)phenyl]benzenesulfonamide is contained. This allows for high sensitivity, excellent thermal background fogging resistance at high temperatures (in particular, 100° C. and 110° C.), and plasticizer resistance. The second developer is preferably 5-(N-3-methylphenyl-sulfonamide)-N′,N″-bis-(3-methylphenyl)-isophthalic acid diamide.

The content of the second developer is not particularly limited, and is about 0.4 to 2.5 parts by mass, preferably about 0.7 to 2.5 parts by mass, more preferably about 0.9 to 2.5 parts by mass, and even more preferably about 1.7 to 2.3 parts by mass, per part by mass of the first developer. A second developer content of 0.4 parts by mass or more can improve plasticizer resistance. A second developer content of 2.5 parts by mass or less can enhance recording performance.

The heat-sensitive recording layer may contain another developer as long as the effects of the present invention are not impaired. Specific examples of the other developer include phenolic compounds, such as 4-tert-butylphenol, 4-acetylphenol, 4-tert-octylphenol, 4,4′-sec-butylidenediphenol, 4-phenylphenol, 4,4′-dihydroxydiphenylmethane, 4,4′-isopropylidenediphenol, 4,4′-cyclohexylidenediphenyl, 4,4′-cyclohexylidenediphenol, 1,1-bis(4-hydroxyphenyl)-ethane, 1,1-bis(4-hydroxyphenyl)-1-phenylethane, 4,4′-bis(p-tolylsulfonylaminocarbonylamino)diphenylmethane, 1,1-bis(4-hydroxyphenyl)cyclohexane, 2,2′-bis[4-(4-hydroxyphenyl)phenoxy]diethyl ether, 4,4′-dihydroxydiphenylsulfide, 4,4′-thiobis(3-methyl-6-tert-butylphenol), 4,4′-dihydroxydiphenyl sulfone, 2,4′-dihydroxydiphenyl sulfone, 2,2-bis(4-hydroxyphenyl)-4-methylpentane, 2,4′-dihydroxydiphenyl sulfone, 4-hydroxy-4′-isopropoxy diphenyl sulfone, 4-hydroxy-4′-n-propoxydiphenylsulfone, 4-hydroxy-4′-allyloxydiphenylsulfone, 4-hydroxy-4′-benzyloxydiphenyl sulfone, 3,3′-diallyl-4,4′-dihydroxydiphenylsulfone, butyl bis(p-hydroxyphenyl)acetate, methyl bis(p-hydroxyphenyl)acetate, hydroquinone monobenzyl ether, bis(3-allyl-4-hydroxyphenyl) sulfone, 4-hydroxy-4′-methyldiphenylsulfone, 4-allyloxy-4′-hydroxydiphenyl sulfone, 3,4-dihydroxyphenyl-4′-methylphenylsulfone, 4-hydroxybenzophenone, dimethyl 4-hydroxyphthalate, methyl 4-hydroxybenzoate, propyl 4-hydroxybenzoate, sec-butyl 4-hydroxybenzoate, phenyl 4-hydroxybenzoate, benzyl 4-hydroxybenzoate, 4-hydroxybenzoic acid benzyl ester, tolyl 4-hydroxybenzoate, chlorophenyl 4-hydroxybenzoate, and 4,4′-dihydroxydiphenyl ether; aromatic carboxylic acids, such as benzoic acid, p-chlorobenzoic acid, p-tert-butylbenzoic acid, trichlorobenzoic acid, terephthalic acid, salicylic acid, 3-tert-butylsalicylic acid, 3-isopropylsalicylic acid, 3-benzylsalicylic acid, 3-(α-methylbenzyl) salicylic acid, 3,5-di-tert-butylsalicylic acid, 4-[2-(p-methoxyphenoxy)ethyloxy]salicylic acid, 4-[3-(p-tolylsulfonyl)propyloxy]salicylic acid, 5-[p-(2-p-methoxyphenoxyethoxy)cumyl]salicylic acid, and zinc 4-[3-(p-tolylsulfonyl)propyloxy]salicylate; salts of these phenolic compounds or aromatic carboxylic acids with, for example, polyvalent metals, such as zinc, magnesium, aluminum, calcium, titanium, manganese, tin, and nickel; antipyrine complex of zinc thiocyanate; organic acidic substances, such as composite zinc salts of terephthalic aldehyde acid and other aromatic carboxylic acids; diaryl ureas, such as N,N′-di[3-(p-toluenesulfonyl)oxy]phenylurea; thiourea compounds, such as N-p-toluenesulfonyl-N′-3-(p-toluenesulfonyloxy)phenylurea, N-p-toluenesulfonyl-N′-p-butoxycarbonylphenylurea, N-p-tolylsulfonyl-N′-phenylurea, and N,N′-di-m-chlorophenylthiourea; organic compounds having a —SO₂NH-bond in the molecule, such as N-(p-toluenesulfonyl) carbamic acid p-cumylphenyl ester, N-(p-toluenesulfonyl) carbamic acid p-benzyloxyphenyl ester, and N-(o-toluoyl)-p-toluenesulfoamide; inorganic acidic substances, such as activated clay, attapulgite, colloidal silica, and aluminum silicate; and the like.

In the present invention, the heat-sensitive recording layer may further contain a stabilizer mainly in order to further enhance the preservation of the developed color image. The stabilizer for use can be those described in the “Heat-sensitive Recording Layer” section in “A. Heat-sensitive Recording Material (A)” above, and the content of the stabilizer can be set as described in the “Heat-sensitive Recording Layer” section in “A. Heat-sensitive Recording Material (A)” above.

In the present invention, the heat-sensitive recording layer may further contain a sensitizer. Use of the sensitizer enhances the recording sensitivity. Examples of usable sensitizers include stearic acid amide, methoxycarbonyl-N-stearic acid benzamide, N-benzoyl stearic acid amide, N-eicosanoic acid amide, ethylenebisstearic acid amide, behenic acid amide, methylenebisstearic acid amide, N-methylol stearic acid amide, dibenzyl terephthalate, dimethyl terephthalate, dioctyl terephthalate, diphenylsulfone, benzyl p-benzyloxybenzoate, phenyl 1-hydroxy-2-naphthoate, 2-naphthyl benzyl ether, m-terphenyl, p-benzylbiphenyl, oxalic acid-di-p-chlorobenzyl ester, oxalic acid-di-p-methylbenzyl ester, oxalic acid-dibenzyl ester, p-tolyl biphenyl ether, di(p-methoxyphenoxyethyl)ether, 1,2-di(3-methylphenoxy)ethane, 1,2-di(4-methylphenoxy)ethane, 1,2-di(4-methoxyphenoxy)ethane, 1,2-di(4-chlorophenoxy)ethane, 1,2-diphenoxyethane, 1-(4-methoxyphenoxy)-2-(3-methylphenoxy)ethane, p-methylthiophenylbenzylether, 1,4-di(phenylthio)butane, p-acetotoluidide, p-acetophenetidide, N-acetoacetyl-p-toluidine, 1,2-diphenoxymethylbenzene, di(B-biphenylethoxy)benzene, p-di(vinyloxyethoxy)benzene, 1-isopropylphenyl-2-phenylethane, di-o-chlorobenzyl adipate, 1,2-bis(3,4-dimethylphenyl)ethane, 1,3-bis(2-naphthoxy) propane, diphenyl, benzophenone, and the like. Of these, dimethyl terephthalate, 1,2-di(3-methylphenoxy)ethane, stearic acid amide, and diphenyl sulfone are preferable, and from the viewpoint of obtaining a sensitizing effect without reducing thermal background fogging resistance at high temperatures, dimethyl terephthalate and 1,2-di(3-methylphenoxy)ethane are more preferable. These sensitizers can be used in combination as long as the combined use does not impair the effects of the present invention. The sensitizer content may be an effective amount for sensitization, and is typically preferably 2 to 25 mass %, more preferably 5 to 20 masse, and even more preferably 5 to 15 mass %, based on the total solids content of the heat-sensitive recording layer.

As other components that constitute the heat-sensitive recording layer, a binder can be used. Further, if necessary, auxiliary agents, such as pigments, crosslinking agents, waxes, metal soaps, water resistance improving agents, dispersants, colored dyes, and fluorescent dyes, can be used. The binder and crosslinking agent for use can be those described in the “Heat-sensitive Recording Layer” section in “A. Heat-sensitive Recording Material (A)” above. The content of the binder and the content of the crosslinking agent can be set as described in the “Heat-sensitive Recording Layer” section in “A. Heat-sensitive Recording Material (A)” above.

The heat-sensitive recording layer is formed on the undercoat layer, for example, by dispersing a leuco dye and developers, and if necessary, with or separately from a sensitizer or a stabilizer, using water as a dispersion medium and using at least one of various stirrers or wet pulverizers, such as a ball mill, a co-ball mill, an attritor, or a vertical or horizontal sand mill together with a water-soluble synthetic polymer compound, such as polyacrylamide, polyvinyl pyrrolidone, polyvinyl alcohol, methylcellulose, or a styrene-maleic anhydride copolymer salt, and other additives such as a surfactant to form dispersions; then mixing the dispersions obtained by reducing the average particle diameter so that the average particle diameter is 2 μm or less optionally with a pigment, a binder, an auxiliary agent, and the like to prepare a coating liquid for a heat-sensitive recording layer; applying the coating liquid for a heat-sensitive recording layer to the undercoat layer; and then drying. The coated amount of the heat-sensitive recording layer is not particularly limited and is preferably about 1 to 12 g/m², more preferably 2 to 10 g/m², even more preferably 2.5 to 8 g/m², and particularly preferably 3 to 5.5 g/m², in terms of the coated amount after drying. Note that the heat-sensitive recording layer may be formed as two or more separate layers if necessary, and the composition and coated amount of each layer may be the same or different.

### Protective Layer

The heat-sensitive recording material can comprise a protective layer formed on the heat-sensitive recording layer as necessary. The protective layer for use can be those described in the “Protective Layer” section in “A. Heat-sensitive Recording Material (A)” above.

### Other Layers

In this embodiment, the heat-sensitive recording material can be further processed to impart higher functionality to it for enhanced added value. Other layers for use can be those described in the “Other Layers” section in “A. Heat-sensitive Recording Material (A)” above.

### Heat-Sensitive Recording Material

The heat-sensitive recording material can be produced by forming the individual layers described above on a support. The method for forming the layers can be the method described in the “Heat-sensitive Recording Material” section in “A. Heat-sensitive Recording Material (A)” above.

### EXAMPLES

The present invention is described in more detail with reference to Examples. However, the present invention is not limited to these Examples. In the Examples, “parts” and “%” represent “parts by mass” and “mass %” unless otherwise specified. The particle diameters, such as average particle diameters and maximum particle diameters, were measured with a SALD2200 laser diffraction particle diameter distribution analyzer (produced by Shimadzu Corporation). “Average particle diameter” as used herein refers to a median diameter (D50).

The hollow particles used in the Examples and Comparative Examples are as follows.
Hollow particles A: average particle diameter (D50): 5.0 μm; maximum particle diameter (D100): 13.5 μm; hollow ratio: 90%; proportion of particles having a particle diameter of 2 μm or less: 0.2 volume %; solids concentration: 15.0%
Hollow particles B: average particle diameter (D50): 11 μm; maximum particle diameter (D100): 23 μm; hollow ratio: 93%; proportion of particles having a particle diameter of 2 μm or less: 0 volume %; solids concentration: 15.0%
Hollow particles C: Ropaque SN-1055 (produced by Dow); average particle diameter (D50): 1.0 μm; maximum particle diameter (D100): 1.8 μm; hollow ratio: 55%; solids concentration: 26.5% The average particle diameters (D50) and maximum particle diameters (D100) of these hollow particles were measured using a SALD2200 laser diffraction particle diameter analyzer (produced by Shimadzu Corporation) at a refractive index of 1.70-0.01i.

The latexes used in the Examples and Comparative Examples are as follows.
Latex A: styrene-butadiene copolymer latex development product (Tg: −35° C.; particle diameter: 300 nm; solids concentration: 48%)
Latex B: styrene-butadiene copolymer latex development product (Tg: −10° C.; particle diameter: 190 nm; solids concentration: 48%)
Latex C: styrene-butadiene copolymer latex (trade name: L-1571, produced by Asahi Kasei Corporation; Tg: −3° C.; particle diameter: 190 nm; solids concentration: 48%)

The inorganic pigments II used in the Examples and Comparative Examples are as follows.
Calcium carbonate: trade name: Brilliant-15, produced by Shiraishi Kogyo Kaisha, Ltd.; oil absorption: 56 ml/100 g
Calcium carbonate: trade name: Cal-Light-KT, produced by Shiraishi Kogyo Kaisha, Ltd.; oil absorption: 120 ml/100 g
Aluminum hydroxide: trade name: Higilite H-42, produced by Showa Denko K.K.; oil absorption: 43 ml/100 g
Clay: trade name: Hydragloss 90, produced by KaMin LLC; oil absorption: 46 ml/100 g
Amorphous silica: trade name: Nipsil E743, produced by Tosoh Silica Corporation; oil absorption: 160 ml/100 g

### A. Heat-Sensitive Recording Material (A)

### Example A1

### (1) Preparation of Coating Liquid for Undercoat Layer

A coating liquid for an undercoat layer was prepared by mixing and stirring 100 parts of hollow particles A, 38 parts of calcined kaolin (trade name: Ansilex 93, produced by BASF; oil absorption: 104 ml/100 g), 79.2 parts of latex A, 32 parts of a 25% solution of oxidized starch, 1.1 parts of carboxymethyl cellulose (trade name: Cellogen AG gum, produced by DKS Co. Ltd.), and 100 parts of water.

### (2) Preparation of Leuco Dye Dispersion (Dispersion A1)

40 parts of 3-di-(n-butyl)amino-6-methyl-7-anilinofluorane, 40 parts of a 10% aqueous solution of polyvinyl alcohol (degree of polymerization: 500, degree of saponification: 88%), and 20 parts of water were mixed. The resulting mixture was pulverized with a sand mill (produced by Imex Co., Ltd., a sand grinder) to an average particle diameter of 0.5 μm, thus obtaining a leuco dye dispersion (dispersion A1).

### (3) Preparation of Developer Dispersion (Dispersion B1)

40 parts of 3-[(phenylcarbamoyl)amino]phenyl-4-methylbenzenesulfonate, 40 parts of a 10% aqueous solution of polyvinyl alcohol (degree of polymerization: 500, degree of saponification: 888), and 20 parts of water were mixed. The resulting mixture was pulverized with a sand mill (produced by Imex Co., Ltd., a sand grinder) to an average particle diameter of 1.0 μm, thus obtaining a developer dispersion (dispersion B1).

### (4) Preparation of Sensitizer Dispersion (Dispersion C1)

40 parts of 1,2-di(3-methylphenoxy)ethane (trade name: KS-232, produced by Sankosha Co., Ltd.), 40 parts of a 10% aqueous solution of polyvinyl alcohol (degree of polymerization: 500, degree of saponification: 88%), and 20 parts of water were mixed. The resulting mixture was pulverized with a sand mill (produced by Imex Co., Ltd., a sand grinder) to an average particle diameter of 1.0 μm, thus obtaining a sensitizer dispersion (dispersion C1).

### (5) Preparation of Coating Liquid for Heat-Sensitive Recording Layer

A coating liquid for a heat-sensitive recording layer was prepared by mixing and stirring 29.5 parts of dispersion A1, 63.6 parts of dispersion B1, 45.5 parts of dispersion C1, 70 parts of a 10% aqueous solution of completely saponified polyvinyl alcohol (trade name: PVA117, degree of saponification: 99 mol %, average degree of polymerization: 1700, produced by Kuraray Co., Ltd.), 20.8 parts of a styrene-butadiene-based copolymer latex (trade name: L-1571, produced by Asahi Kasei Corporation, solids concentration: 48%), 20 parts of calcium carbonate (trade name: Brilliant-15, produced by Shiraishi Kogyo Kaisha, Ltd., oil absorption: 56 ml/100 g), 2 parts of adipic acid dihydrazide (produced by Otsuka Chemical Co., Ltd.), and 150 parts of water.

### (6) Preparation of Coating Liquid for Protective Layer

A coating liquid for a protective layer was prepared by mixing and stirring a composition containing 317 parts of a 12% aqueous solution of diacetone-modified polyvinyl alcohol (trade name: DF-10, produced by Japan Vam & Poval Co., Ltd.), 60 parts of kaolin (trade name: Hydragloss 90, produced by KaMin LLC), 0.5 parts of polyethylene wax (trade name: Chemipearl W-400, produced by Mitsui Chemicals, Inc., solids concentration: 40%), 5 parts of zinc stearate (trade name: Hidorin Z-8-36, produced by Chukyo Yushi Co., Ltd., solids concentration: 36%), and 300 parts of water.

### (7) Production of Heat-Sensitive Recording Material

The coating liquid for an undercoat layer, the coating liquid for a heat-sensitive recording layer, and the coating liquid for a protective layer were applied in amounts after drying of 4.5 g/m², 3.8 g/m², and 2.3 g/m², respectively, to one surface of high-quality paper having a basis weight of 60 g/m², and dried to form an undercoat layer, a heat-sensitive recording layer, and a protective layer in this order. The obtained product was then super-calendered to smooth the surface, thus obtaining a heat-sensitive recording material.

### Example A2

A heat-sensitive recording material was obtained in the same manner as in Example A1, except that in the preparation of the coating liquid for a heat-sensitive recording layer of Example A1, aluminum hydroxide (trade name: Higilite H-42, produced by Showa Keikinzoku, oil absorption: 43 ml/100 g) was used in place of calcium carbonate.

### Example A3

A heat-sensitive recording material was obtained in the same manner as in Example A1, except that in the preparation of the coating liquid for a heat-sensitive recording layer of Example A1, clay (trade name: HG90, produced by KaMin LLC, oil absorption: 46 ml/100 g) was used in place of calcium carbonate.

### Example A4

A heat-sensitive recording material was obtained in the same manner as in Example A1, except that in the preparation of the coating liquid for a heat-sensitive recording layer of Example A1, calcium carbonate (trade name: Cal-Light-KT, produced by Shiraishi Kogyo Kaisha, Ltd., oil absorption: 120 ml/100 g) was used in place of calcium carbonate (trade name: Brilliant-15, produced by Shiraishi Kogyo Kaisha, Ltd., oil absorption: 56 ml/100 g).

### Example A5

A heat-sensitive recording material was obtained in the same manner as in Example A1, except that in the preparation of the coating liquid for an undercoat layer of Example A1, 79.2 parts of latex B was used in place of 79.2 parts of latex A.

### Example A6

A heat-sensitive recording material was obtained in the same manner as in Example A1, except that in the preparation of the coating liquid for an undercoat layer of Example A1, 79.2 parts of latex C was used in place of 79.2 parts of latex A.

### Example A7

A heat-sensitive recording material was obtained in the same manner as in Example A1, except that in the preparation of the coating liquid for an undercoat layer of Example A1,100 parts of hollow particles B was used in place of 100 parts of hollow particles A.

### Example A8

A heat-sensitive recording material was obtained in the same manner as in Example A1, except that in the preparation of the coating liquid for an undercoat layer of Example A1, the amount of calcined kaolin was changed from 38 parts to 66 parts, the amount of latex A was changed from 79.2 parts to 20.8 parts, and the amount of water was changed from 100 parts to 130 parts.

### Example A9

A heat-sensitive recording material was obtained in the same manner as in Example A1, except that in the preparation of the coating liquid for an undercoat layer of Example A1, the amount of calcined kaolin was changed from 38 parts to 66 parts, 20.8 parts of latex C was used in place of 79.2 parts of latex A, 56.6 parts of hollow particles C was used in place of 100 parts of hollow particles A, and the amount of water was changed from 100 parts to 180 parts.

### Comparative Example A1

A heat-sensitive recording material was obtained in the same manner as in Example A1, except that in the preparation of the coating liquid for a heat-sensitive recording layer of Example A1, amorphous silica (trade name: Nipsil E743, produced by Tosoh Silica Corporation) was used in place of calcium carbonate.

### Comparative Example A2

### (8) Preparation of Developer Dispersion (Dispersion D1)

40 parts of 4-hydroxy-4′-isopropoxy diphenyl sulfone (trade name: D-8, produced by Nippon Soda Co., Ltd.), 40 parts of a 10% aqueous solution of polyvinyl alcohol (degree of polymerization: 500, degree of saponification: 88%), and 20 parts of water were mixed. The resulting mixture was pulverized with a sand mill (produced by Imex Co., Ltd., a sand grinder) to an average particle diameter of 1.0 μm, thus obtaining a developer dispersion (dispersion D1).

A heat-sensitive recording material was obtained in the same manner as in Comparative Example A1, except that in the preparation of the coating liquid for a heat-sensitive recording layer of Comparative Example A1, developer dispersion D1 was used in place of developer dispersion B1.

The Examples and Comparative Examples were evaluated according to the following methods. Table 1 shows the results.

### Recording Density

An image was recorded on each heat-sensitive recording material at applied energies of 0.13 mJ/dot (medium energy color density) and 0.18 mJ/dot (high energy color density) using a thermal recording tester (trade name: TH-PMD, produced by Ohkura Electric Co., Ltd.). The printed portion was measured with a spectrodensitometer (X-Rite 504, produced by X-Rite). A larger value indicates a denser print.
The evaluation criteria for medium energy color density were the following.
   A color density of 0.90 or more: compatible with high-speed printing, very good
   A color density of less than 0.90 and 0.80 or more: needed for practical use
   A color density of less than 0.80: low sensitivity with many defects such as white spots, problematic in practical use
The evaluation criteria for high energy color density were the following.
   A color density of 1.30 or more: very good
   A color density of less than 1.30 and 1.20 or more: needed for practical use
   A color density of less than 1.20: low printing density, undesirable for practical use

### Long-Term Preservation of Printing

An image was recorded on each heat-sensitive recording material at applied energies of 0.13 mJ/dot (medium energy color density) and 0.18 mJ/dot (high energy color density) using a thermal recording tester (trade name: TH-PMD, produced by Ohkura Electric Co., Ltd.). After each heat-sensitive recording material was allowed to stand in the dark at 23° C. and 50% RH for 3 months, the optical density in the case of the medium energy color density and in the case of the high energy color density was measured with a spectrodensitometer (X-Rite 504, produced by X-Rite). Further, the remaining percentage of the recorded portion was determined according to the following equation.

Remaining percentage (%)=(recording density after treatment/recording density before treatment)×100
The evaluation criteria were the following.
   A remaining percentage of 95% or more: very good
   A remaining percentage of less than 95% and 85% or more: good
   A remaining percentage of less than 85% and 80% or more: no practical problem
   A remaining percentage of less than 80%: the recording density after treatment is low, which is problematic in practical use

### 90° C. Heat Resistance

A sample of each heat-sensitive recording material that had been subjected to color development using a label printer (trade name: L-2000, produced by Ishida Co., Ltd.) was allowed to stand in a chamber at 90° C. for 1 hour. After the treatment, the optical density of the blank-paper portion was measured with a spectrodensitometer (X-Rite 504, produced by X-Rite).
The evaluation criteria were the following.
   A density of the post-treatment blank-paper portion of 0.10 or less: very good
   A density of the post-treatment blank-paper portion of more than 0.10 and 0.20 or less: no problem in practical use
   A density of the post-treatment blank-paper portion of more than 0.20: background fogging is too strong, which is problematic for practical use

TABLE 1

| | | | | | | | 90° C. Heat Resistance | |
|---|---|---|---|---|---|---|---|---|
| | | | Long-term Preservation of Printing | | | | | Blank- |
| | | | (23° C. and 50% RH for 3 months) | | | | Blank- | paper |
| | Initial Color Density | | 0.13 (mJ/dot) | | 0.18 (mJ/dot) | | paper | Portion |
| | 0.13 | 0.18 | Remaining | Remaining | Remaining | Remaining | Portion | (After |
| | (mJ/dot) | (mJ/dot) | Density | Percentage | Density | Percentage | (Untreated) | Treatment) |
| Ex. A1 | 0.93 | 1.36 | 0.85 | 91.4% | 1.37 | 100.7% | 0.06 | 0.09 |
| Ex. A2 | 0.97 | 1.33 | 0.84 | 86.6% | 1.33 | 100.0% | 0.06 | 0.09 |
| Ex. A3 | 0.95 | 1.34 | 0.84 | 88.4% | 1.35 | 100.7% | 0.06 | 0.09 |
| Ex. A4 | 0.92 | 1.31 | 0.75 | 81.5% | 1.30 | 99.2% | 0.06 | 0.09 |
| Ex. A5 | 0.89 | 1.33 | 0.81 | 91.0% | 1.32 | 99.2% | 0.06 | 0.09 |
| Ex. A6 | 0.83 | 1.30 | 0.76 | 91.6% | 1.29 | 99.2% | 0.06 | 0.09 |
| Ex. A7 | 0.94 | 1.32 | 0.84 | 89.4% | 1.32 | 100.0% | 0.07 | 0.10 |
| Ex. A8 | 0.85 | 1.29 | 0.76 | 89.4% | 1.30 | 100.8% | 0.06 | 0.09 |
| Ex. A9 | 0.65 | 1.21 | 0.60 | 92.3% | 1.21 | 100.0% | 0.07 | 0.11 |
| Comp. | 0.92 | 1.29 | 0.32 | 34.8% | 1.16 | 89.9% | 0.06 | 0.06 |
| Ex. A1 | | | | | | | | |
| Comp. | 0.98 | 1.39 | 0.98 | 100.0% | 1.40 | 100.7% | 0.08 | 0.94 |
| Ex. A2 | | | | | | | | |

As shown in Table 1, the recording density of each of the heat-sensitive recording materials of Examples A1 to A8 was excellent, and there were no practical problems in the long-term preservation of printing of each of the heat-sensitive recording materials of Examples A1 to A8. Although the medium energy density of the heat-sensitive recording material of Example A9 was low, there were no practical problems in the long-term preservation of printing of the heat-sensitive recording material of Example A9. In contrast, the long-term preservation of printing of Comparative Example A1 was significantly poor. Comparative Example A2 showed excellent recording density and long-term preservation of printing by changing the developer; however, the density of the blank-paper portion in the 90° C. heat resistance evaluation was poor.

### B. Heat-Sensitive Recording Material (B)

### Example B1

### (1) Preparation of Coating Liquid for Undercoat Layer

A coating liquid for an undercoat layer was obtained by mixing and stirring 56.6 parts of hollow particles C, 70 parts of calcined kaolin (trade name: Ansilex 93, produced by BASF, oil absorption: 105 ml/100 g), 22.9 parts of latex C, 12 parts of a 25% solution of oxidized starch, 6.7 parts of a 15% aqueous solution of completely saponified polyvinyl alcohol (trade name: PVA105, degree of saponification: 99 mol %, average degree of polymerization: 500, produced by Kuraray Co., Ltd.) and 80 parts of water.

### (2) Preparation of Leuco Dye Dispersion (Dispersion A2)

40 parts of 3-di-(n-butyl)amino-6-methyl-7-anilinofluorane, 40 parts of a 10% aqueous solution of polyvinyl alcohol (trade name: PVA205, degree of polymerization: 500, degree of saponification: 88%, produced by Kuraray Co., Ltd.), and 20 parts of water were mixed. The resulting mixture was pulverized with a sand mill (produced by Imex Co., Ltd., a sand grinder) to an average particle diameter of 0.5 μm, thus obtaining a leuco dye dispersion (dispersion A2).

### (3) Preparation of Developer Dispersion (Dispersion B2)

40 parts of 3-[(phenylcarbamoyl)amino]phenyl-4-methylbenzenesulfonate, 40 parts of a 10% aqueous solution of polyvinyl alcohol (trade name: PVA205, degree of polymerization: 500, degree of saponification: 88%, produced by Kuraray Co., Ltd.), and 20 parts of water were mixed. The resulting mixture was pulverized with a sand mill (produced by Imex Co., Ltd., a sand grinder) to an average particle diameter of 1.0 μm, thus obtaining a developer dispersion (dispersion B2).

### (4) Preparation of Developer Dispersion (Dispersion C2)

40 parts of 5-(N-3-methylphenyl-sulfonamide)-N′,N″-bis-(3-methylphenyl)-isophthalic acid diamide, 40 parts of a 10% aqueous solution of polyvinyl alcohol (trade name: PVA205, degree of polymerization: 500, degree of saponification: 88%, produced by Kuraray Co., Ltd.), and 20 parts of water were mixed. The resulting mixture was pulverized with a sand mill (produced by Imex Co., Ltd., a sand grinder) to an average particle diameter of 1.0 μm, thus obtaining a developer dispersion (dispersion C2).

### (5) Preparation of Sensitizer Dispersion (Dispersion D2)

40 parts of dimethyl terephthalate (produced by Tokyo Chemical Industry Co., Ltd.), 40 parts of a 10% aqueous solution of polyvinyl alcohol (trade name: PVA205, degree of polymerization: 500, degree of saponification: 88%, produced by Kuraray Co., Ltd.), and 20 parts of water were mixed. The resulting mixture was pulverized with a sand mill (produced by Imex Co., Ltd., a sand grinder) to an average particle diameter of 1.0 μm, thus obtaining a sensitizer dispersion (dispersion D2).

### (6) Preparation of Coating Liquid for Heat-Sensitive Recording Layer

A coating liquid for a heat-sensitive recording layer was obtained by mixing and stirring 34.1 parts of dispersion A2, 46.7 parts of dispersion B2, 22.7 parts of dispersion C2, 35 parts of dispersion D2, 63.7 parts of a 15% aqueous solution of completely saponified polyvinyl alcohol (trade name: PVA110, degree of saponification: 99 mol %, average degree of polymerization: 1000, produced by Kuraray Co., Ltd.), 12.8 parts of latex C (trade name: L-1571, produced by Asahi Kasei Corporation, solids concentration: 48%), 21 parts of calcium carbonate (trade name: Brilliant-15, produced by Shiraishi Kogyo Kaisha, Ltd., oil absorption: 56 ml/100 g), 1 part of adipic acid dihydrazide (produced by Otsuka Chemical Co., Ltd.), and 150 parts of water.

### (7) Preparation of Coating Liquid for Protective Layer

A coating liquid for a protective layer was obtained by mixing and stirring a composition containing 292 parts of a 12% aqueous solution of acetoacetyl-modified polyvinyl alcohol (trade name: Gohsenx Z-200, produced by Nippon Synthetic Chemical Industry Co., Ltd.), 62 parts of kaolin (trade name: Hydragloss 90, produced by KaMin LLC), 8.3 parts of zinc stearate (trade name: Hidorin Z-9-36, produced by Chukyo Yushi Co., Ltd., solids concentration: 36%), and 150 parts of water.

### (8) Production of Heat-Sensitive Recording Material

The coating liquid for an undercoat layer, the coating liquid for a heat-sensitive recording layer, and the coating liquid for a protective layer were applied in amounts after drying of 6.5 g/m², 3.5 g/m², and 2.3 g/m², respectively, to one surface of high-quality paper having a basis weight of 60 g/m², and dried to form an undercoat layer, a heat-sensitive recording layer, and a protective layer in this order. The obtained product was then super-calendered to smooth the surface, thus obtaining a heat-sensitive recording material.

### Example B2

A heat-sensitive recording material was obtained in the same manner as in Example B1, except that in the preparation of the coating liquid for a heat-sensitive recording layer of Example B1, the amount of dispersion C2 was changed from 22.7 parts to 34.1 parts, and the amount of calcium carbonate was changed from 21 parts to 16 parts.

### Example B3

A heat-sensitive recording material was obtained in the same manner as in Example B1, except that in the preparation of the coating liquid for a heat-sensitive recording layer of Example B1, the amount of dispersion C2 was changed from 22.7 parts to 45.5 parts, and the amount of calcium carbonate was changed from 21 parts to 11 parts.

### Example B4

A heat-sensitive recording material was obtained in the same manner as in Example B1, except that in the preparation of the coating liquid for a heat-sensitive recording layer of Example B1, the amount of dispersion B2 was changed from 47.7 parts to 22.7 parts, and the amount of dispersion C2 was changed from 22.7 parts to 47.7 parts.

### Example B5

### (9) Preparation of Sensitizer Dispersion (Dispersion E2)

40 parts of 1,2-di(3-methylphenoxy)ethane (trade name: KS-232, produced by Sankosha Co., Ltd.), 40 parts of a 10% aqueous solution of polyvinyl alcohol (trade name: PVA205, degree of polymerization: 500, degree of saponification: 88%, produced by Kuraray Co., Ltd.), and 20 parts of water were mixed. The resulting mixture was pulverized with a sand mill (produced by Imex Co., Ltd., a sand grinder) to an average particle diameter of 1.0 μm, thus obtaining a sensitizer dispersion (dispersion E2).

A heat-sensitive recording material was obtained in the same manner as in Example B1, except that in the preparation of the coating liquid for a heat-sensitive recording layer of Example B1, dispersion E2 was used in place of dispersion D2.

### Example B6

A heat-sensitive recording material was obtained in the same manner as in Example B1, except that in the preparation of the coating liquid for a heat-sensitive recording layer of Example B1, 64 parts of Hymicron L-271 (main component: stearic acid amide, produced by Chukyo Yushi Co., Ltd., solids concentration: 25%) was used in place of 36.4 parts of dispersion D2.

### Example B7

### (10) Preparation of Sensitizer Dispersion (Dispersion F2)

40 parts of diphenyl sulfone (produced by Nicca Chemical Co., Ltd.), 40 parts of a 10% aqueous solution of polyvinyl alcohol (trade name: PVA205, degree of polymerization: 500, degree of saponification: 88%, produced by Kuraray Co., Ltd.), and 20 parts of water were mixed. The resulting mixture was pulverized with a sand mill (produced by Imex Co., Ltd., a sand grinder) to an average particle diameter of 1.0 μm, thus obtaining a sensitizer dispersion (dispersion F2).

A heat-sensitive recording material was obtained in the same manner as in Example B1, except that in the preparation of the coating liquid for an undercoat layer of Example B1, dispersion F2 was used in place of dispersion D2.

### Example B8

### (11) Preparation of Developer Dispersion (Dispersion G2)

40 parts of N-[2-(3-phenylureido)phenyl]benzenesulfonamide (trade name: NKK-1304, produced by Nippon Soda Co., Ltd.), 40 parts of a 10% aqueous solution of polyvinyl alcohol (trade name: PVA205, degree of polymerization: 500, degree of saponification: 88%, produced by Kuraray Co., Ltd.), and 20 parts of water were mixed. The resulting mixture was pulverized with a sand mill (produced by Imex Co., Ltd., a sand grinder) to an average particle diameter of 1.0 μm, thus obtaining a developer dispersion (dispersion G2).

A heat-sensitive recording material was obtained in the same manner as in Example B1, except that in the preparation of the coating liquid for a heat-sensitive recording layer of Example B1, dispersion G2 was used in place of dispersion C2.

### Example B9

A heat-sensitive recording material was obtained in the same manner as in Example B1, except that in the preparation of the coating liquid for a heat-sensitive recording layer of Example B1, the amount of dispersion B2 was changed from 47.7 parts to 22.7 parts, and 47.7 parts of dispersion G2 was used in place of 22.7 parts of dispersion C2.

### Example B10

A heat-sensitive recording material was obtained in the same manner as in Example B4, except that in the preparation of the coating liquid for an undercoat layer of Example B4, 66.7 parts of hollow particles B was used in place of 56.6 parts of hollow particles C, the amount of calcined kaolin (trade name: Ansilex 93, produced by BASF; oil absorption: 105 ml/100 g) was changed from 70 parts to 30 parts, the amount of latex C was changed from 22.9 parts to 95.8 parts, the amount of the 25% solution of oxidized starch was changed from 12 parts to 40 parts, and the amount of water was changed from 80 parts to 0 parts.

### Example B11

A heat-sensitive recording material was obtained in the same manner as in Example B10, except that in the preparation of the coating liquid for an undercoat layer of Example B10, 66.7 parts of hollow particles A was used in place of 66.7 parts of hollow particles B.

### Example B12

A heat-sensitive recording material was obtained in the same manner as in Example B10, except that in the preparation of the coating liquid for an undercoat layer of Example B10, 95.8 parts of latex B was used in place of 95.8 parts of latex C.

### Example B13

A heat-sensitive recording material was obtained in the same manner as in Example B10, except that in the preparation of the coating liquid for an undercoat layer of Example B10, 95.8 parts of latex A was used in place of 95.8 parts of latex C.

### Comparative Example B1

### (12) Preparation of Developer Dispersion (Dispersion H2)

40 parts of 4-hydroxy-4′-isopropoxy diphenyl sulfone (trade name: D-8, produced by Nippon Soda Co., Ltd.), 40 parts of a 10% aqueous solution of polyvinyl alcohol (trade name: PVA205, degree of polymerization: 500, degree of saponification: 88%, produced by Kuraray Co., Ltd.), and 20 parts of water were mixed. The resulting mixture was pulverized with a sand mill (produced by Imex Co., Ltd., a sand grinder) to an average particle diameter of 1.0 μm, thus obtaining a developer dispersion (dispersion H2).

A heat-sensitive recording material was obtained in the same manner as in Example B1, except that in the preparation of the coating liquid for a heat-sensitive recording layer of Example B1, dispersion H2 was used in place of dispersion B2.

### Comparative Example B2

### (13) Preparation of Developer Dispersion (Dispersion J2)

40 parts of N-p-toluenesulfonyl-N′-3-(p-toluenesulfonyloxy)phenylurea (trade name: PF201, produced by Solenis), 40 parts of a 10% aqueous solution of polyvinyl alcohol (trade name: PVA205, degree of polymerization: 500, degree of saponification: 88%, produced by Kuraray Co., Ltd.), and 20 parts of water were mixed. The resulting mixture was pulverized with a sand mill (produced by Imex Co., Ltd., a sand grinder) to an average particle diameter of 1.0 μm, thus obtaining a developer dispersion (dispersion J2).

A heat-sensitive recording material was obtained in the same manner as in Example B1, except that in the preparation of the coating liquid for a heat-sensitive recording layer of Example B1, dispersion J2 was used in place of dispersion B2, the amount of dispersion C2 was changed from 22.7 parts to 0 parts, and the amount of calcium carbonate was changed from 21 parts to 31 parts.

### Comparative Example B3

A heat-sensitive recording material was obtained in the same manner as in Example B1, except that in the preparation of the coating liquid for a heat-sensitive recording layer of Example B1, the amount of dispersion B2 was changed from 47.7 parts to 0 parts, the amount of dispersion C2 was changed from 22.7 parts to 44.7 parts, and the amount of calcium carbonate was changed from 21 parts to 31 parts.

The Examples and Comparative Examples were evaluated according to the following methods. Table 4 shows the results.

### Recording Density

An image was recorded on each heat-sensitive recording material at an applied energy of 0.18 mJ/dot (medium energy color density) using a thermal recording tester (trade name: TH-PMD, produced by Ohkura Electric Co., Ltd.). The printed portion was measured with a spectrodensitometer (X-Rite 504, produced by X-Rite). A larger value indicates a denser print.
The evaluation criteria for medium energy color density were the following.
   A color density of 1.25 or more: compatible with high-speed printing, very good
   A color density of 1.10 or more and less than 1.25: needed for practical use
   A color density of less than 1.10: low sensitivity with many defects such as white spots, problematic in practical use

An image was recorded on each heat-sensitive recording material at an applied energy of 0.25 mJ/dot (maximum color density) using a thermal recording tester (trade name: TH-PMD, produced by Ohkura Electric Co., Ltd.). The printed portion was measured with a spectrodensitometer (X-Rite 504, produced by X-Rite). A larger value indicates a denser print.
The evaluation criteria for maximum color density were the following.
   A color density of 1.40 or more: compatible with high-speed printing, very good
   A color density of 1.30 or more and less than 1.40: needed for practical use
   A color density of less than 1.30: low sensitivity with many defects such as white spots, problematic in practical use

### Plasticizer Resistance

A wrap film (trade name: Hi-S Soft, produced by Nippon Carbide Industries Co., Inc.) was wound around a polycarbonate pipe (diameter: 40 mm) three times, and a heat-sensitive recording material that had been subjected to color development using a label printer (trade name: L-2000, produced by Ishida Co., Ltd.) was placed on the film. A wrap film was further wound around the heat-sensitive recording material three times, and the wrapped heat-sensitive recording material was allowed to stand at 50° C. for 24 hours. After this treatment, the optical density of the recorded portion was measured with a spectrodensitometer (X-Rite 504, produced by X-Rite), and the remaining percentage was calculated according to the following: remaining percentage=(printing density after treatment)÷(printing density before treatment).
The evaluation criteria for the remaining percentage were the following.
   A remaining percentage after treatment of 65% or more: bar code readable, good
   A remaining percentage after treatment of 40% or more and less than 65%: visually legible, no practical problem
   A remaining percentage after treatment of less than 40%: printing is lost, which is problematic in practical use

### 100° C. Heat Resistance

A sample of each heat-sensitive recording material that had been subjected to color development using a label printer (trade name: L-2000, produced by Ishida Co., Ltd.) was allowed to stand in a chamber at 100° C. for 1 hour. After the treatment, the optical density of the blank-paper portion was measured with a spectrodensitometer (X-Rite 504, produced by X-Rite).
The evaluation criteria were the following.

TABLE 2

| | Background Density in Heat |
|---|---|
| | Resistance Evaluation |
| | 100° C. × 1 H |
| Evaluation Results | Density after Treatment |
| Very good | 0.10 or less |
| Good | More than 0.10 and less |
| | than 0.20 |
| Problematic in | 0.20 or more |
| practical use | |

### 110° C. Heat Resistance

A sample of each heat-sensitive recording material that had been subjected to color development using a label printer (trade name: L-2000, produced by Ishida Co., Ltd.) was allowed to stand in a chamber at 110° C. for 1 hour. After the treatment, the optical density of the blank-paper portion was measured with a spectrodensitometer (X-Rite 504, produced by X-Rite).
The evaluation criteria were the following.

TABLE 3

| | Background Density in Heat |
|---|---|
| | Resistance Evaluation |
| | 110° C. × 1 H |
| Evaluation Results | Density after Treatment |
| Very good | 0.15 or less |
| Good | More than 0.15 and less |
| | than 0.30 |
| Problematic in | 0.30 or more |
| practical use | |

TABLE 4

| | | | Preservation Test | | | | |
|---|---|---|---|---|---|---|---|
| | | | | Plasticizer | Thermal Background Fogging Resistance | | |
| | Color Density | | | Resistance | | 100° C. × 1H | 110° C. × 1H |
| | 0.18 | 0.25 | Untreated | Remaining | Density before | Density after | Density after |
| | (mJ/dot) | (mJ/dot) | Density | Percentage (%) | Treatment | Treatment | Treatment |
| Example B1 | 1.27 | 1.45 | 1.44 | 41% | 0.04 | 0.07 | 0.10 |
| Example B2 | 1.33 | 1.49 | 1.47 | 55% | 0.04 | 0.07 | 0.11 |
| Example B3 | 1.33 | 1.45 | 1.46 | 66% | 0.04 | 0.07 | 0.11 |
| Example B4 | 1.11 | 1.36 | 1.36 | 73% | 0.04 | 0.07 | 0.11 |
| Example B5 | 1.30 | 1.43 | 1.41 | 41% | 0.04 | 0.08 | 0.13 |
| Example B6 | 1.26 | 1.41 | 1.39 | 42% | 0.04 | 0.15 | 0.29 |
| Example B7 | 1.26 | 1.41 | 1.42 | 40% | 0.04 | 0.12 | 0.25 |
| Example B8 | 1.38 | 1.46 | 1.47 | 56% | 0.04 | 0.12 | 0.26 |
| Example B9 | 1.35 | 1.48 | 1.46 | 66% | 0.04 | 0.11 | 0.25 |
| Example B10 | 1.35 | 1.48 | 1.47 | 75% | 0.04 | 0.07 | 0.12 |
| Example B11 | 1.36 | 1.49 | 1.47 | 76% | 0.04 | 0.07 | 0.11 |
| Example B12 | 1.36 | 1.48 | 1.47 | 76% | 0.04 | 0.07 | 0.11 |
| Example B13 | 1.36 | 1.48 | 1.47 | 75% | 0.04 | 0.07 | 0.12 |
| Comparative | 1.21 | 1.32 | 1.33 | 43% | 0.04 | 0.97 | 1.13 |
| Example B1 | | | | | | | |
| Comparative | 1.16 | 1.29 | 1.27 | 47% | 0.05 | 0.24 | 0.39 |
| Example B2 | | | | | | | |
| Comparative | 0.73 | 1.10 | 1.08 | 67% | 0.04 | 0.05 | 0.05 |
| Example B3 | | | | | | | |

1. A heat-sensitive recording material comprising at least an undercoat layer and a heat-sensitive recording layer in this order on a support,
the undercoat layer containing hollow particles and a binder,
the heat-sensitive recording layer containing a leuco dye and a developer,
the heat-sensitive recording material containing a compound represented by the following formula (1) as a first developer of the heat-sensitive recording layer: 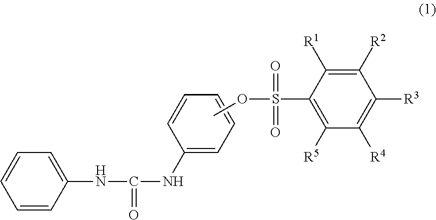
wherein R¹ to R⁵ are the same or different, and each represents a hydrogen atom, a halogen atom, a nitro group, an amino group, an alkyl group, an alkoxy group, an aryloxy group, an alkylcarbonyloxy group, an arylcarbonyloxy group, an alkylcarbonylamino group, an arylcarbonylamino group, an alkylsulfonylamino group, an arylsulfonylamino group, a monoalkylamino group, a dialkylamino group, or an arylamino group,
the heat-sensitive recording material satisfying either the following requirement (A) or (B):
(A) the undercoat layer contains an inorganic pigment I, and the heat-sensitive recording layer contains a pigment with an oil absorption of 130 ml/100 g or less as an inorganic pigment II; or
(B) the heat-sensitive recording layer contains 5-(N-3-methylphenyl-sulfonamide)-N′,N″-bis-(3-methylphenyl)-isophthalic acid diamide or N-[2-(3-phenylureido)phenyl]benzenesulfonamide as a second developer, and the second developer is contained in an amount of 0.4 to 2.5 parts by mass per part by mass of the first developer.

2. The heat-sensitive recording material according to claim 1, wherein the compound represented by formula (1) is at least one member selected from the group consisting of 3-[(phenylcarbamoyl)amino]phenyl-4-methylbenzenesulfonate, 2-[(phenylcarbamoyl)amino]phenyl-4-methylbenzenesulfonate, and 4-[(phenylcarbamoyl)amino]phenyl-4-methylbenzenesulfonate.

3. The heat-sensitive recording material according to claim 1, which satisfies requirement (A).

4. The heat-sensitive recording material according to claim 3, wherein the content of the inorganic pigment I is 60 mass % or less, based on the total solids content of the undercoat layer.

5. The heat-sensitive recording material according to claim 3, wherein the inorganic pigment I has an oil absorption of 130 ml/100 g or less.

6. The heat-sensitive recording material according to claim 3, wherein the inorganic pigment II is at least one member selected from the group consisting of calcium carbonate, aluminum hydroxide, and clay.

7. The heat-sensitive recording material according to claim 1, which satisfies requirement (B).

8. The heat-sensitive recording material according to claim 7, wherein the second developer is contained in an amount of 0.9 to 2.5 parts by mass per part by mass of the first developer.

9. The heat-sensitive recording material according to claim 7, wherein the heat-sensitive recording layer contains at least one sensitizer selected from the group consisting of dimethyl terephthalate, 1,2-di(3-methylphenoxy)ethane, stearic acid amide, and diphenyl sulfone.

10. The heat-sensitive recording material according to claim 3, wherein the hollow particles have a maximum particle diameter (D100) of 10 to 30 μm and an average particle diameter (D50) of 3 to 15 μm, the ratio of the maximum particle diameter (D100) to the average particle diameter (D50), which is D100/D50, is 1.8 to 3.0, and the volume % of hollow particles with a particle diameter of 2.0 μm or less is 1% or less.

11. The heat-sensitive recording material according to claim 7, wherein the hollow particles have a maximum particle diameter (D100) of 10 to 30 μm and an average particle diameter (D50) of 4.0 to 15 μm, the ratio of the maximum particle diameter (D100) to the average particle diameter (D50), which is D100/D50, is 1.8 to 3.0, and the volume % of hollow particles with a particle diameter of 2.0 μm or less is 1% or less.

12. The heat-sensitive recording material according to claim 1, wherein the hollow particles have a hollow ratio of 80 to 98%.

13. The heat-sensitive recording material according to claim 1, wherein the content of the hollow particles is 5 to 40 mass % based on the total solids content of the undercoat layer.

14. The heat-sensitive recording material according to claim 1, wherein the binder of the undercoat layer contains a binder resin with a glass transition temperature of −10° C. or lower.
